(19) United States
(12) Patent Application Publication
(10) Pub. No.: US 2024/0109797 A1
(43) Pub. Date: Apr. 4, 2024

(54) Systems and Methods for Systems and Methods Using Thermophilic Microbes for the Treatment of Wastewater

(71) Applicant: Advanced Innovators, Inc., Fleming Island, FL (US)

(72) Inventors: Robert Whiteman, Fleming Island, FL (US); Christopher Whiteman, Fleming Island, FL (US)

(73) Assignee: Advanced Innovators, Inc., Fleming Island, FL (US)

(21) Appl. No.: 18/305,324

(22) Filed: Apr. 21, 2023

Related U.S. Application Data
(60) Provisional application No. 63/333,164, filed on Apr. 21, 2022.

(51) Int. Cl. C02F 3/30; C02F 11/02

(52) U.S. Cl. CPC C02F 3/30; C02F 11/02; C02F 2103/28

(57) ABSTRACT

A method of providing and using thermophilic microbes for the treatment of high temperature wastewater, for the treatment of wastewater in elevated environmental temperatures and both. High temperature wastewater treatment systems using thermophilic microbes for treating waste water for use in conjunction with an industrial facility, using water in its processing or manufacturing of products or materials, such as a paper mill, pulp mill or both. In Thermophilic treatment methods and systems provide solutions that allow, among other things, a manufacturing industry, such as the pulp and paper industry, to achieve one or more and all of: reduced energy costs; increased water conservation; and increased water recycling and reuse.

The present application claims priority to and claims under 35 U.S.C. § 119(e)(1) the benefit of the filing date of U.S. provisional application Ser. No. 63/333,164 filed Apr. 21, 2022, the entire disclosure of which is incorporated herein by reference.

### BACKGROUND OF THE INVENTION

### Field of the Invention

The present inventions relate to the treatment of wastewater with biological materials, systems and methods for preforming such treatments, and the production from wastewater of useful, safe and environmentally acceptable materials, including liquids.

In a particular embodiment the present inventions relate to the application of thermophilic microbes for the treatment of high temperature wastewater in systems designed for mesophilic treatment.

In general wastewater treatment systems handle effluent from municipalities, industrial sites, factories, storm drainage systems and other locations where water that has been contaminated with undesirable materials is present. As used herein, unless stated otherwise the terms “wastewater treatment system” and “waste water treatment plant” should be given its broadest possible meaning and would include: industrial systems, mesophilic systems, municipal systems, and systems having primary treatment, secondary treatment or tertiary treatment and combinations and variations of these; aerobic, facultative, or anaerobic biological wastewater systems; aerobic processes include, for example, activated sludge systems, aerobic stabilization basins (ASB), aerated lagoons, single pass lagoon systems, stabilization ponds, rotating biological contactors, and trickling filters; facultative processes include, for example, facultative lagoons; anaerobic processes include, for example, anaerobic ponds, anaerobic digesters, anaerobic filters or contactors, and anaerobic treatment systems; systems having clarifiers, settling tanks, digesters, activated sludge systems, lagoons, single pass lagoons, and combinations and variations of these; systems such as activated sludge systems, rotating disc systems, submerged aerated filter, suspended media filters, sequencing batch reactors non-electric filters and trickling filters; and combinations and variations of these and other device for cleaning wastewater.

Wastewater treatment plants can range from small volumes per day, measures in flow per day, i.e., gallons per day (GPD) to large volumes measured in flows of million (1,000,000) gallons per day (MGD). The flow can be 10s, 100s, 1,000s, 10,000s, and 100,000s of GPD. Typically, for municipal and industrial sites, the flow of wastewater is in the hundreds of thousands GPD to millions of gallons per day, and for example can be from about 0.5 MGD and greater, about 0.8 MGD and greater, about 1 MGD and greater, about 2 MGD and greater, about 5 MGD and greater, from about 0.3 MGD to about 60 MGD, from about 0.5 MGD to about 2 MGD, from about 2 MGD to about 60 MGD, from about 1 MGD to 100 MGD, from 5 MGD to 50 MGD, from about 0.5 MGD to about 15 MGD, from about 2 MGD to about 60 MGD, from about 1 MGD to about 60 MGD, from about 2 MGD to about 50 MGD, from about 25 MGD to about 70 MGD, from about 50 MGD to about 300 MGD, and greater and smaller, flows as well as, all flows within these ranges.

The capacity or size of a wastewater treatment plant can also be measured in Population Equivalent (“PE”). PE is standardization that is used to measure flow, and compare flow between different treatment plants. PE is the number expressing the ratio of the sum of pollution load produced during 24 hours by industry facilities and service to the individual population in household sewage produced by one person in the same time.

$$PE = \frac{BOD load from industry [ \frac{k g}{day} ]}{0.0 \; 54 [ \frac{k g}{inhab \cdot day} ]}$$

Typically, one unit of PE is equal to 54 grams of BOD per 24 hours. In flow, a unit of PE typically equates to 50 gallons per person per day or 200 liters per person per day. Wastewater treatment plants can have capacities of 10,000 to 200,000 PE, 50,000 to 100,000 PE, 50,000 to 500,000 PE, 100,000 PE to 2,000,000 (2 mm) PE, 1 mm PE to 4 mm PE, and all capacities within this range, and greater and smaller capacities.

As used herein, unless specifically stated otherwise, the term “influent” should be given it broadest possible meaning, and refers to wastewater or other liquid—raw (untreated) or partially treated—flowing into a device, system, apparatus, reservoir, basin, treatment process treatment system, treatment device, tank, or treatment plant or treatment facility.

As used herein, unless specifically stated otherwise, the term “sludge” should be given its broadest possible meaning, and would include the material that is removed from wastewater by a wastewater treatment plant. Typically, sludge can have from about 0.2% to about 80% solids, about 1% to about 60% solids, about 0.25% to 0.5% solids, about 2% to about 4% solids, about 50% to about 99% solids, about 5% to about 25% solids, about 5% solids, about 10% solids, about 1% solids, about 10% solids, about 15% solids, greater than about 0.5% solids, greater than about 2% solids, greater than about 5% solids, and combinations and variations of these as well as all values within these ranges. The removal of sludge from the waste water treatment plant can be referred to as wastage, and typically involves the wastage of primary, secondary or both solids. The solids removed can be put through a volume and mass reduction processes. Industrial sludge typically will just go through a volume reduction processes such as clarification followed by dewatering via belt press centrifuge to produce a cake to be hauled off site.

As used herein, unless specifically stated otherwise, the terms “floc forming microbes”, “floc formers”, floc forming, and similar such terms should be given their broadest possible meaning, including a generic group of microbes that cause floc formation or flocculate resulting in large clumps or communities of bacteria working together; including: floc forming bacteria (saprophytes:) Achromobacter, Flavobacterium, Alcaligenes, Arthrobacter, Zooglea, Acinetobacter, Citromonas; Psuedomonas; predators: protozoa, rotifers, nematodes Vorticella, Aspicidica, Paramedium; Phosphate accumulating organisms (PAO), algae (lagoons).

As used herein, unless stated otherwise, room temperature is 25° C. (77° F.). And, standard temperature and pressure is 25° C. (77° F.) and 1 atmosphere.

As used herein, unless specified otherwise, the term “mesophilic temperature range” means a temperature within the range of 5° C. (35° F.) to 35° C. (95° F.).

As used herein, unless specified otherwise, the terms “higher wastewater temperatures”, “high temperature systems”, “high temperature wastewater” and similar such terms, refers to wastewater temperatures of more than 35° C. (95° F.) and in particular, wastewater temperatures of 37° C. (98.6° F.) and greater, about 41° C. (105.8° F.) and greater, about 45° C. (113° F.) and greater, from 37° C. (98.6° F.) to about 60° C. (140° F.) and from about 40° C. (104° F.) to about 55° C. (131° F.).

Generally, the term “about” as used herein unless specified otherwise is meant to encompass the large of: a variance or range of ±10%; or the experimental or instrument error associated with obtaining the stated value.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

### Relevant Art and Long-Standing Problem

Most biological wastewater treatment systems are designed to operate at ambient temperature, which generally means temperatures of 5-35° C. (41-95° F.) or in microbiology terms developing biomass that grows in the mesophilic temperature range. FIG. 1 shows an example of how bacterial growth rate specifically for methanogens changes depending on temperature (Evans, Emily Blair, “The Effect of Temperature on the Performance of Anaerobic Membrane Bioreactors for Treatment of Domestic Wastewater” (2019). These general trends are similar for all bacteria as shown in FIG. 2.

The growth rate of various microbes based upon temperature is set forth in Evans, Emily Blair, “The Effect of Temperature on the Performance of Anaerobic Membrane Bioreactors for Treatment of Domestic Wastewater” (2019), and J. Gottschal, R. Prins “Thermophiles: A life at elevated temperatures.” (Published in Trends in ecology & evolution 1991), the entirety of each of which are incorporated herein by reference.

However, many industrial wastewater streams are warmer than 35° C. (95° F.), which is the optimum temperature for treatment at mesophilic temperatures. This leads to a commercial tradeoff between the capital and operating cost of reducing temperature of the effluent to optimize biological treatment versus the reduced efficiency of treatment and increased cost. The Pulp and Paper industry is one of the largest industrial users of water and as such facing the 21^{st} century challenges of reduced fossil fuel consumption and reducing water usage through loop closures as described in “Usable Excess Heat in Future Kraft Pulp Mills” by Ulrika Wising and Thore Berntsson of Department of Heat and Power Technology 412 96 Goteborg, Sweden and Anders Asbald, CIT Industriell Energianalys AB, 412 88 Goteborg, Sweden.

EPA promulgated initial Effluent Guidelines and Standards for the Pulp, Paper and Paperboard category (40 CFR Part 430 (e.g., https://www.ecfr.gov/current/title-40/chapter-I/subchapter-N/part-430) in 1974 and 1977, amended the regulations in 1982 and 1986, and promulgated a major amendment covering toxic pollutants in 1998. The Effluent Guidelines are incorporated into NPDES permits for direct dischargers, and permits or other control mechanisms for indirect dischargers (see Pretreatment Program https://www.epa.dov/npdes/national-pretreatment-program). The 1998 “Cluster Rule” also promulgated toxic air emission standards (NESHAPs) for the industry under the Clean Air Act (see Pulp and Paper Production (MACT I & III) https://www.epa.gov/stationary-sources-air-pollution/pulp-and-paper-production-mact-i-iii-national-emissions-standards). The entirety of each of which is incorporated herein by reference. In the USA, the “Cluster Rules” requiring capture (See THE BASICS OF FOUL CONDENSATE STRIPPING Ben Lin, P. Eng., M. Eng. A. H. Lundberg Systems Ltd. Suite 300-5118 Joyce Street Vancouver, B. C. V5R 4H1 CANADA/) or treatment of foul condensates by hard-piping this hot wastewater at 50-70° C. (122-158° F.) directly to the biological treatment system (See, e.g., FIG. 2).

According to a paper entitled and incorporated herein by reference “Degradation of Pulp and Paper-Mill Effluent by Thermophilic Micro-Organisms using Batch Systems” by Prenaven Reddy, Visvanathan L Pillay, Adinarayana Kunamneni and Suren Singh of the Department of Biotechnology, Durban Institute of Technology, PO Box 1334, Durban 4000, South Africa, published in Water SA, Vol. 31, No 4 Oct. 2005 the average temperature for wastewater from pulp and paper industry is 50° C. (122° F.). This research examined thermophilic treatment of pulp and paper wastewater but used mesophilic bacteria as the source of inocula and therefore was a study on mesophilic bacteria and the impact of thermophilic temperatures on biological treatment finding the optimum temperature to be 40° C. (104° F.) for treatment compared to 50° C. (122° F.) or 60° C. (140° F.), which would be expected for mesophilic microbiology as indicated in FIGS. 1 and 2.

This research provides an example of the problem that is increasing and remains unsolved until the present inventions. Many industrial facilities, for example, and in particular pulp and paper mills, are using water loop closures for reducing water usage, and using these closures to greater and greater extents. Pulp and paper mills, and in particular pulp mills, as well as other industries, require these high water temperatures in their operations. These water loop closures (e.g., “closures”, “closed systems”, “closed-loops”) are leading to higher wastewater effluent temperatures, which are negatively impacting mesophilic biological treatment as shown in FIGS. 1 and 2, because the wastewater is above the optimum temperature for mesophilic activity falling at best in the circle shown in FIG. 2. This problem of higher temperature water entering the wastewater treatment system, as a result of increasing closures is significantly reducing the efficiency and efficacy of these higher temperature systems (e.g., more that 35° C. (95° F.)), and increasing their cost of operation, among other problems.

Increasing temperatures, and in particular increasing temperatures in the summer in southern states in the United States, and other locations nearer to and in tropic zones throughout the world, have also contributed to and compounded this ever increasing problem of higher temperatures, and in particular higher wastewater temperatures above 35° C. (95° F.) and in particular above 45° C. (113° F.). Thus, the problems of rising wastewater temperatures from increasing closures of the wastewater systems are exasperated in more tropical regions by rising global temperatures.

These increases in wastewater temperatures, and in particular in higher temperature systems, promote the growth of potentially dangerous microbes, which in some of these higher temperature systems do not regulate, monitored or controlled. Thus, pathogens such as fecal contaminants such as Klebsiella species and Escherichia coli which have optimum growth rates of 37° C., thrive in rich carbohydrate environments such as pulp and paper wastewater. With increasing temperatures of the effluent these microorganisms have an ecological advantage over non-pathogenic mesophilic bacteria. See the following reference incorporated herein Microbiology Research International Vol. 4(3), pp. 28-39, September 2016 ISSN: 2354-2128 Pulp and paper mill wastewater and coliform as health hazards: A review; Chhatarpal Singh, Pankaj Chowdhary, Jay Shankar Singh* and Ram Chandra; Department of Environmental Microbiology, Babasaheb Bhimrao Ambedkar (Central) University, Lucknow-226025, Uttar Pradesh, India.

Further industry specific studies included herein by reference were done by the National Council for Air and Stream Improvement (NCASI) Technical Bulletin number 0905 “Bacterial Assessment of Pulp and Paper Mill Effluents” showing interference in current test methods.

Unlike municipal wastewater treatment, historically industrial facilities, such as the pulp and paper industry have not been required to chlorinate, ozonate or do any other form of disinfection nor had fecal contamination limits included in their discharge permits. While, several States in the United States are now starting to implement fecal limits on these discharges including, for example, Florida (FL) and Georgia (GA), the art has failed to provide methods and systems that can meet these new requirements in high temperature systems, absent the installation of costly mitigation systems such as chlorination, ozonation or the use of chemicals such as peracetic acid (PAA). For example, chemical usage can be costly and inefficient, with chemical cost alone being well into the millions of dollars annually. Thus, the long standing and ever increasing problem of efficiently and efficaciously operating higher wastewater temperature systems, is of heightened significance in industries, such as the pulp and paper industry, which typically does not mitigate or treat, against these potentially dangerous microbes.

Prior to the present inventions the art attempted to address the problems of high wastewater temperatures through the use of cooling systems, e.g., cooling towers, for the wastewater. The cooling tower approach is costly and has been less than adequate, and will not be able to address in an economic manner, a technical manner, and both, the problems of higher temperature wastewater systems, from increasing closure of these systems, and well as, increasing environmental temperatures related to climate change and global warming, i.e., weather, air temperatures. Traditional solutions have been to install cooling towers to lower wastewater temperatures from 48-50° C. (118-122° F.) with the goal of reaching 35-40° C. (95-105° F.). However, the cooling towers are limited by ambient air temperature, which means that unless air temperatures are well below the water temperature, e.g., less than about 15° C. (59° F.), the wastewater is always too warm and never reaches the mesophilic optimum of 35° C. (95° F.). Thus, the use of cooling towers cannot address the increasing wastewater temperature from increasing systems closures, as well as, the air temperatures and increasing air temperatures. Furthermore, these cooling towers are ideal grounds for biological growth and fecal coliforms. Thus, and in particular with rising temperatures (wastewater, air and both), they contribute to this ever increasing problem of growing potentially dangerous microbes, rather than address it. For example, any biology growing in these cooling towers then continually seeds (bioaugments) the biological treatment system where further growth of these undesirable or pathogenic microbes occurs. Ultimately, the result is contamination of the effluent discharge which will exceed any limits for coliforms. This in turn leads to the requirement to disinfect the effluent, which requires very large amounts of water: millions of gallons per day and consequently millions of dollars in operating costs to reduce the fecal coliforms to be within discharge permit limits.

Thus, as set forth above, as well as potentially other reasons, prior approaches to address the problems associated with treating higher temperature wastewater, and operating high temperature systems, have been costly, ineffective, and contributed to the problems.

This Background of the Invention section is intended to introduce various aspects of the art, which may be associated with embodiments of the present inventions. Thus, the forgoing discussion in this section provides a framework for better understanding the present inventions, and is not to be viewed as an admission of prior art.

### SUMMARY

There has been a long-standing and ever increasing problem with rising temperatures in wastewater treatment plants, both wastewater, air and both, and the adverse effects that these higher temperatures have on the treatment of the wastewater in these plants and the ability to provide effluent from these plants that meets present and future standards, and is clean and safe for discharge into the environment. These longstanding problems have been further exasperated by increased closure of facilities, the location of more facilities in warmer clients, climate change and global warming. The present inventions, among other things, solve these needs and problems by providing the compositions of matter, materials, articles of manufacture, devices and processes taught, disclosed and claimed herein.

Thus, the present inventions, among other things, provide systems and methods to operate high temperature wastewater treatment faculties in a safe, efficient and efficacious manner.

Thus, there is provided a method and systems for operation the method, of treating a high temperature wastewater stream, the method including: in a wastewater treatment system having an influent stream of wastewater containing pollutants, the wastewater treatment system having a first treatment device, and a second treatment device; wherein the wastewater flows from the first treatment device to the second treatment device; adding a plurality of thermophiles (e.g., thermophilic microbes) to the high temperature wastewater in the wastewater treatment system at a controlled and predetermined dosing rate; the microbes selected to remove the pollutants from the high temperature wastewater; the plurality of thermophilic microbes containing from about 10³ cfu/ml to 10¹³ cfu/ml.

Further. There is provided these methods and systems having one or more of the following features: wherein the pollutants in the wastewater are reduced providing an effluent having pollutants as measured by DOD and TSS reduced by at least about 50% from the influent wastewater stream; wherein the pollutants in the wastewater are reduced providing an effluent having pollutants as measured by DOD and TSS reduced by at least about 90% from the influent wastewater stream; wherein the wastewater treatment plant has a throughput of about 10,000 GPD to about 500,000 GPD; wherein the wastewater treatment plant has a throughput of about 0.5 MGD to about 2 MGD; wherein the wastewater treatment plant has a throughput of about 2 MGD to about 60 MGD; wherein the wastewater treatment plant has a throughput of about 20 MGD to about 100 MGD; wherein the wastewater treatment plant has a throughput of about 2 MGD and greater; wherein the thermophilic microbes are added to the first treatment device; wherein the thermophilic microbes are added to the second treatment device; wherein the wastewater treatment system comprises a third treatment device; wherein the wastewater flows from the second treatment device to the third treatment device; wherein the thermophilic microbes are added to the third treatment device; wherein the microbes are added to the second and third treatment devices; whereby the dose rate is cumulative of a dose rate for each treatment device; wherein the influent wastewater stream has a temperature of greater than 35° C. (95° F.); wherein the influent wastewater stream has a temperature of about 37° C. (98.6° F.) and greater; wherein the influent wastewater stream has a temperature of about 41° C. (105.8° F.) and greater; wherein the influent wastewater stream has a temperature of from 37° C. (98.6° F.) to about 55° C. (131° F.); wherein an ambient air temperature at the wastewater treatment system is greater than 15° C. (59° F.); wherein an ambient air temperature at the wastewater treatment system is about 30° C. (86° F.) and greater; wherein an ambient air temperature at the wastewater treatment system is from about 27° C. (80.6° F.) to 39° C. (102.2° F.); wherein mesophilic microbes are added to the wastewater; wherein a temperature of the wastewater at a point of addition of the mesophilic microbes is at least 5° C. (25° F.) cooler than the temperature of the influent wastewater stream; wherein a temperature of the wastewater at a point of addition of the mesophilic microbes is at least 10° C. (50° F.) cooler than the temperature of the influent wastewater stream; wherein a temperature of the wastewater at a point of addition of the mesophilic microbes is at least 15° C. (59° F.) cooler than the temperature of the influent wastewater stream; wherein a temperature of the wastewater at a point of addition of the mesophilic microbes is at least 20° C. (68° F.) cooler than the temperature of the influent wastewater stream; wherein a temperature of the wastewater at a point of addition of the mesophilic microbes is at least 5° C. (25° F.) cooler than the temperature of the wastewater at a point of addition of the thermophilic microbes; wherein a temperature of the wastewater at a point of addition of the mesophilic microbes is at least 10° C. (50° F.) cooler than the temperature of the influent wastewater stream; wherein a temperature of the wastewater at a point of addition of the mesophilic microbes is at least 15° C. (59° F.) cooler than the temperature of the influent wastewater stream; wherein a sludge is produced; and, wherein a temperature of the wastewater at a point of addition of the mesophilic microbes is at least 20° C. (68° F.) cooler than the temperature of the influent wastewater stream.

In addition there is provided a method of treating a high temperature wastewater stream, and a system operating such method, the method including: in a wastewater treatment system having an influent stream of wastewater containing pollutants, the wastewater treatment system having a first treatment device, a second treatment device a third treatment device and a fourth treatment device; adding a plurality of thermopiles (e.g., thermophilic microbes) to the high temperature wastewater in the wastewater treatment system at a controlled and predetermined dosing rate; the microbes selected to remove the pollutants from the high temperature wastewater; the plurality of thermophilic microbes containing from about 10³ cfu/ml to 10¹³ cfu/ml; wherein the first treatment device comprises screens and a girt chamber, where by large particles, plastic and girt are removed from the wastewater; wherein the second treatment device comprises a basin; wherein the third treatment device comprises a settling tank; wherein a return stream comprising an activated sludge is flowed to the second treatment device; wherein the effluent is flowed from the third treatment device; wherein the fourth treatment device comprises a holding tank; wherein sludge from the third treatment device is flowed to the fourth treatment device; wherein the sludge is thickened.

Moreover, there is provided these methods and systems having one or more of the following features; wherein the pollutants in the wastewater are reduced providing an effluent having pollutants as measured by DOD and TSS reduced by at least about 50% from the influent wastewater stream; wherein the pollutants in the wastewater are reduced providing an effluent having pollutants as measured by DOD and TSS reduced by at least about 90% from the influent wastewater stream; wherein the wastewater treatment plant has a throughput of about 10,000 GPD to about 500,000 GPD; wherein the wastewater treatment plant has a throughput of about 0.5 MGD to about 2 MGD; wherein the wastewater treatment plant has a throughput of about 2 MGD to about 60 MGD; wherein the wastewater treatment plant has a throughput of about 20 MGD to about 100 MGD; wherein the wastewater treatment plant has a throughput of about 2 MGD and greater; wherein the thermophilic microbes are added to the first treatment device; wherein the thermophilic microbes are added to the second treatment device; wherein the thermophilic microbes are added to the third device; wherein the thermophilic microbes are added to the fourth treatment device; wherein the microbes are added to a plurality of the treatment devices; whereby the dose rate is cumulative of a dose rate for each treatment device; wherein the influent wastewater stream has a temperature of greater than 35° C. (95° F.); wherein the influent wastewater stream has a temperature of about 37° C. (98.6° F.) and greater; wherein the influent wastewater stream has a temperature of about 41° C. (105.8° F.) and greater; wherein the influent wastewater stream has a temperature of from 37° C. (98.6° F.) to about 55° C. (131° F.); wherein an ambient air temperature at the wastewater treatment system is greater than 15° C. (59° F.); wherein an ambient air temperature at the wastewater treatment system is about 30° C. (86° F.) and greater; wherein an ambient air temperature at the wastewater treatment system is from about 27° C. (80.6° F.) to 39° C. (102.2° F.); wherein mesophilic microbes are added to the wastewater; wherein a temperature of the wastewater at a point of addition of the mesophilic microbes is at least 5° C. (25° F.) cooler than the temperature of the influent wastewater stream; wherein a temperature of the wastewater at a point of addition of the mesophilic microbes is at least 10° C. (50° F.) cooler than the temperature of the influent wastewater stream; wherein a temperature of the wastewater at a point of addition of the mesophilic microbes is at least 15° C. (59° F.) cooler than the temperature of the influent wastewater stream; wherein a temperature of the wastewater at a point of addition of the mesophilic microbes is at least 20° C. (68° F.) cooler than the temperature of the influent wastewater stream; wherein a temperature of the wastewater at a point of addition of the mesophilic microbes is at least 5° C. (25° F.) cooler than the temperature of the wastewater at a point of addition of the thermophilic microbes; wherein a temperature of the wastewater at a point of addition of the mesophilic microbes is at least 10° C. (50° F.) cooler than the temperature of the influent wastewater stream; wherein a second dose of microbes is added to the fourth treatment device; wherein the second device does not have oxygen added to it; and, wherein a temperature of the wastewater at a point of addition of the mesophilic microbes is at least 15° C. (59° F.) cooler than the temperature of the influent wastewater stream; wherein a temperature of the wastewater at a point of addition of the mesophilic microbes is at least 20° C. (68° F.) cooler than the temperature of the influent wastewater stream.

Still further, there is provided these methods and systems having one or more of the following features: wherein the sludge has a fecal coliform level of less than 1,000 most probable number (MPN) per gram of total solids (dry weight), and a salmonella sp. bacterium of less than 3 MPN per 4 grams total solids (dry weight).

Further, there is provided these methods and systems having one or more of the following features: wherein the influent wastewater stream is from a paper mill; and wherein the influent wastewater stream is from a pulp mill.

Additionally, there is provided these methods and systems having one or more of the following features: wherein at least 50% of the effluent from the wastewater treatment system is reused; wherein at least 60% of the effluent from the wastewater treatment system is reused; wherein at least 80% of the effluent from the wastewater treatment system is reused; wherein at least 90% of the effluent from the wastewater treatment system is reused; and, wherein at least 95% of the effluent from the wastewater treatment system is reused.

### BRIEF DESCRIPTION OF THE DRAWINGS

FIG. 1 is a schematic of a temperature/growth graph showing and comparing the growth rate of thermophiles in accordance with embodiments of the present inventions.

FIG. 2 is a schematic of a temperature/growth graph showing and comparing the growth rate of thermophiles in accordance with embodiments of the present inventions.

FIG. 3 is a schematic flow diagram of an embodiment of a wastewater treatment plant in which embodiments of the present inventions can be used and applied in accordance with the present inventions.

FIG. 4 is a schematic flow diagram of an embodiment of a wastewater treatment plant in which embodiments of the present inventions can be used and applied in accordance with the present inventions.

FIG. 5 is a schematic table of process water usage in a paper mill process in which embodiments of the present inventions can be used and applied in accordance with the present inventions.

FIG. 6 is a chart illustrating embodiments of conditions of at wastewater treatment in which embodiments of the present methods and systems can be used and applied in accordance with the present inventions.

FIG. 7 is a chart illustrating embodiments of conditions of at wastewater treatment in which embodiments of the present methods and systems can be used and applied in accordance with the present inventions.

FIG. 8A is a chart illustrating embodiments of conditions of at wastewater treatment in which embodiments of the present methods and systems can be used and applied in accordance with the present inventions.

FIG. 8B is a chart illustrating embodiments of conditions of at wastewater treatment in which embodiments of the present methods and systems can be used and applied in accordance with the present inventions.

FIG. 9 is a chart illustrating embodiments of conditions of at wastewater treatment in which embodiments of the present methods and systems can be used and applied in accordance with the present inventions.

FIG. 10 is a chart illustrating embodiments of conditions of at wastewater treatment in which embodiments of the present methods and systems can be used and applied in accordance with the present inventions.

FIG. 11 shows in comparison 4 photomicrographs showing microbes.

FIG. 12 is a chart illustrating embodiments of conditions of at wastewater treatment in which embodiments of the present methods and systems can be used and applied in accordance with the present inventions.

FIG. 13 is a chart illustrating embodiments of conditions of at wastewater treatment in which embodiments of the present methods and systems can be used and applied in accordance with the present inventions.

FIG. 14 shows in comparison 2 photomicrographs showing microbes.

FIG. 15 is a chart illustrating embodiments of conditions of at wastewater treatment in which embodiments of the present methods and systems can be used and applied in accordance with the present inventions.

### DESCRIPTION OF THE PREFERRED EMBODIMENTS

In general, the present inventions relate to systems, apparatus and processes for treating wastewater to reduce the amount of pollutants that is produced by and discharged from wastewater treatment plants. Thus, embodiments of the present inventions relate to the treatment of wastewater with biological materials, systems and methods for preforming such treatments.

Generally, in embodiments of the present inventions there are provided systems and methods for the treatment of higher temperature wastewater. In particular there are provided systems and methods for the treatment of wastewater having temperatures of more than 35° C. (95° F.), 37° C. (98.6° F.) and greater, about 41° C. (105.8° F.) and greater, about 45° C. (113° F.) and greater, from 37° C. (98.6° F.) to about 60° C. (140° F.) and from about 40° C. (104° F.) to about 55° C. (131° F.). Thus, these embodiments include the present embodiments of thermophilic treatments, methods and systems, which use thermophiles (e.g., thermophilic microbes and thermophilic cultures) in the wastewater treatment systems and methods.

Generally, in embodiments of the present inventions there are provided systems and methods for the treatment of wastewater, and in particular high temperature wastewater, when high environmental temperatures, e.g., air temperature, weather, are present. In particular, there are provided systems and methods for the treatment of higher temperature wastewater when the air temperature is greater than 15° C. (59° F.), about 20° C. (68° F.) and greater, about 30° C. (86° F.) and greater, about 35° C. (95° F.) and greater, from about 18° C. (64.4° F.) to 38° C. (100.4° F.) from about 27° C. (80.6° F.) to 39° C. (102.2° F.) and from 15° C. (59° F.) to 39° C. (102.2° F.). Thus, these embodiments include the present embodiments of thermophilic treatments, methods and systems, which use thermophiles in the wastewater treatment systems and methods.

Generally, in embodiments of the present inventions there are provided systems and methods for the treatment of higher temperature wastewater (e.g., greater than 35° C. (95° F.), 37° C. (98.6° F.) and greater, about 41° C. (105.8° F.) and greater, about 45° C. (113° F.) and greater, about 50° C. (122° F.) and greater, from 37° C. (98.6° F.) to about 60° C. (140° F.) and from about 40° C. (104° F.) to about 55° C. (131° F.)) where the air temperature (e.g., ambient air temperature at the treatment facility) is greater than 15° C. (59° F.), about 20° C. (68° F.) and greater, about 30° C. (86° F.) and greater, 35° C. (95° F.) and greater, from about 18° C. (64.4° F.) to about 38° C. (100.4° F.), from about 27° C. (80.6° F.) to 39° C. (102.2° F.) and from 15° C. (59° F.) to 39° C. (102.2° F.). Thus, these embodiments include the present embodiments of thermophilic treatments, methods and systems, which use thermophiles in the wastewater treatment systems and methods.

Although this specification primarily focusses on the treatment of pulp and paper industry wastewater treatment plants, the present inventions are not so limited. Embodiments of the present systems and methods set forth in this specification find use, applicability and provide benefits to other types and industrial wastewater treatment plants, such as municipal treatment plants, and those in the mining industries, and commercial (factory) farming and livestock facilities.

Typically, wastewater treatment and wastewater treatment systems or facilities involve from two to three stages, called primary, secondary and tertiary treatments. In industrial plants, which are plants that are not handling municipal waste, such as sewage, street runoff or both, generally only primary and secondary treatments are used. Embodiments of the present inventions, including the embodiments of the examples, find use and benefit in any of these systems, or other systems, that are experiencing higher wastewater temperatures, higher environmental temperatures and both.

Apparatus that may be used in wastewater treatment facilities or systems may be for example, aerobic, facultative, or anaerobic biological wastewater systems. They may include, for example, one or more of activated sludge systems, aerobic stabilization basins (ASB), aerated lagoons, single pass lagoon systems, stabilization ponds, rotating biological contactors, trickling filters, facultative lagoons, anaerobic ponds, anaerobic digesters, anaerobic filters or contactors, and anaerobic treatment systems, and combinations of these and other devices.

Primary or sedimentation treatment/stage consists of temporarily holding the influent wastewater in a quiescent basin where heavy solids can settle to the bottom while fats, oils, grease and lighter solids float to the surface. The settled and floating materials are removed and the remaining liquid may be discharged or subjected to secondary treatment. In the primary stage, wastewater flows through large tanks, commonly called “primary clarifiers” or “primary sedimentation tanks.” The term “clarifier” refers to settling tank or sedimentation basin,” which are tanks or basins in which wastewater is held for a period of time, during which the heavier solids settle to the bottom and, if present, the lighter material will float to the water surface. The tanks are large enough that sludge can settle and floating material, if present, such as grease and oils can rise to the surface and be skimmed off. The main purpose of the primary sedimentation stage is to produce both a generally homogeneous liquid capable of being treated biologically and a sludge that can be separately treated or processed. Primary settling tanks are usually equipped with mechanically driven scrapers that continually drive the collected sludge towards a hopper in the base of a tank from where it can be pumped to further sludge treatment stages.

Secondary treatment removes dissolved and suspended biological matter. Secondary treatment is typically performed by indigenous, water-borne micro-organisms in a managed habitat, namely the biological waste treatment system. Secondary treatment requires a separation process to remove the micro-organisms from the treated water prior to discharge or tertiary treatment. It is this secondary treatment stage that is most adversely affected by increases in wastewater temperature, increased environmental temperature (such as, air temperature, weather) and both; and for which the present inventions provide benefits, among others.

Tertiary treatment is sometimes defined as anything more than primary and secondary treatment. Treated water is sometimes disinfected chemically or physically (for example by lagoons and microfiltration) prior to discharge into a stream, river, bay, lagoon or wetland, or it can be used for the irrigation of a golf course, green way or park. If it is sufficiently clean, it can also be used for groundwater recharge or agricultural purposes. The present inventions, in particular, in industrial settings, may avoid or reduce the need for these tertiary treatment stages, where they would be otherwise needed, when wastewater temperatures increase, environmental temperatures increase (e.g., air temperature, weather) and both.

Many industrial systems, such as, plants, facilities, for example, and in particular pulp and paper mills, are using water loop closures to reduce water usage in their production and manufacturing processes. Environmental and other regulatory pressures are causing these water loop closures to be used to greater and greater extents. The water loop closures result from the reuse of more and more of the wastewater in the manufacturing system, such as, in the pulp making processes or in the paper making processes. Typically, as the processing water becomes dirtier, it is used in a process that can tolerate the added pollutants, and so on, until is it sent to the wastewater treatment plant, where some or all of the effluent from the wastewater treatment plant is then reused in the manufacturing process as clean water. The water loop closures result in industrial systems, including its wastewater treatment plant, being closed (i.e., 50% or more of the effluent is reused in the manufacturing or production processes), substantially closed (80% or more of the effluent is reused in the manufacturing or production process) and completely closed (more than 95% of the effluent is reused in the production or manufacturing process). It being understood that as the system becomes more and more closed, the amount of fresh water needed to be added to the system for use in the production or manufacturing process decreased. Thus, the reuse of the wastewater, e.g., effluent, in the production or manufacturing system results in the need for less fresh water to be added to the production or manufacturing system during operation. A significant disadvantage, and problem, with these closed systems is that the temperature of the water in the system, including in the wastewater treatment facility becomes increasing hotter, resulting in high temperature wastewater and high temperature wastewater systems (e.g., water temperatures of more than 35° C. (95° F.))

Moreover over, in many industries high water temperatures are required, beneficial or both, such as in pulp and paper mills, and in particular pulp mills. The high operating temperatures, coupled with water loop closures further increases the temperatures of the wastewater in the treatment facility.

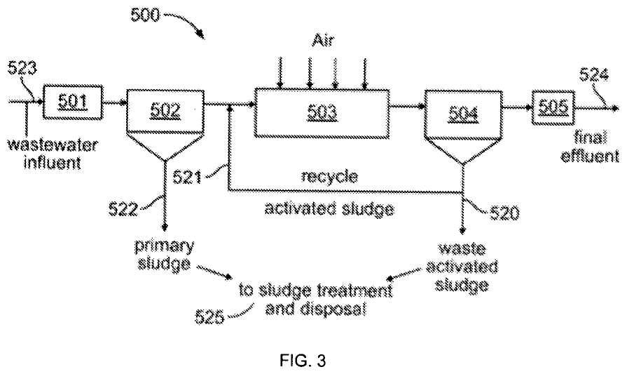

Turning to FIG. 3 there is shown a schematic of an example of a wastewater treatment plant in which embodiments of the present inventions can be used and applied, including the embodiments of the examples. It being understood, that this schematic is only for illustration purposes, that that other configurations, arrangements and types of equipment can be present. Thus, there is shown a schematic of a wastewater treatment plant 500. The plant 500 is associated with an industrial facility that has a manufacturing or production process that uses water, such as, a pulp mill or a paper mill. The plant handles the wastewater from that facility. The plant 500 has waste water influent 523 that enters a preliminary treatment unit 501, then flows to a primary clarifier 502. Sludge from the primary clarifier 502 leaves the clarifier by line 522 and goes to sludge treatment and disposal 525. The waste water leaving the clarifier 502 enters the aeration tank 503, where air is added. The waste leaves the aeration tank 503 and enters a secondary clarifier 504. The treated water leaves the secondary clarifier 504 and goes through a disinfection unit 505 and is discharged as effluent 524. The activated sludge from the secondary clarifier is returned via line 521 to the aeration tank 503, or is sent via line 520 to sludge treatment and disposal 525.

In the embodiment of FIG. 3 the effluent 524 can be reused in an industrial process that typically produced the wastewater in the first place, such as, paper or pulp making. This system of FIG. 3, in conjunction with an industrial facility, operation an industrial process can become more and more closed as, and wastewater temperatures will typically increase, as for instance, 50% of the effluent is reused, 60% of the effluent is reused, 80% of the effluent is reused, 90% of the effluent is reused, and potentially 100% of the effluent is reused. As the level of closure increases the temperature of the wastewater will increase.

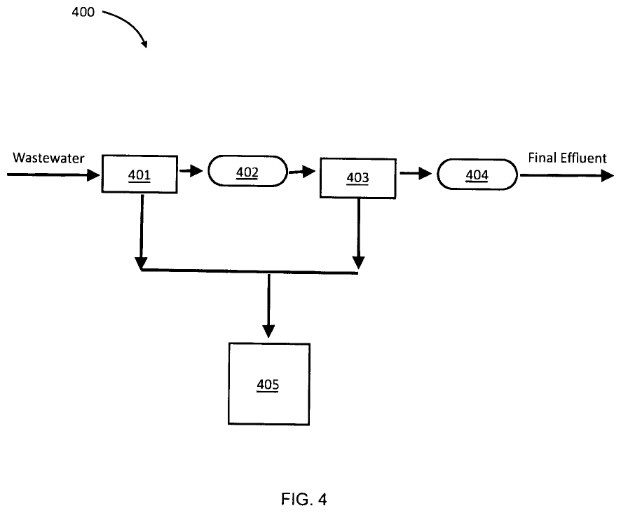

Turning to FIG. 4 there is a schematic of an example of a wastewater treatment plant, for example that may be found at a paper or pulp mill, in which embodiments of the present inventions, including the embodiments of the examples, can be used and applied, including the embodiments of the examples. It being understood, that this schematic is only for illustration purposes, that that other configurations, arrangements and types of equipment can be present. The wastewater treatment system or facility 400 has an incoming wastewater stream, from a paper mill, a pulp mill or both, that is feed into a primary settling tank 401, where a stream of solids is removed and sent to drying system 405. The wastewater leaves tank 401 and flows into a first aerated lagoon 402, from there the wastewater flows to a secondary settling tank 403, where a stream of solids is removed and sent to drying system 405. From settling tank 403 the wastewater flows to second aerated lagoon 404. The effluent is then discharged from lagoon 404 for partial or complete reuse in pulp mill, the paper mill or both.

Thus, the system will become more and more closed as, and wastewater temperatures will typically increase, as for instance, 50% of the effluent is reused, 60% of the effluent is reused, 80% of the effluent is reused, 90% of the effluent is reused, and potentially 100% of the effluent is reused. As the level of closure increases the temperature of the wastewater will increase.

An embodiment of a wastewater treatment plant in which embodiments of the present inventions, including the embodiments of the examples, can be used is a single pass lagoon system, the influent, which can be the wastewater from an industrial process is first directed to a primary clarifier in which solids are allowed to settle. Then the wastewater is passed through an aerated lagoon, and then into a settling pond, before the effluent is discharges or reused. In the single pass system, there is typically a continuous flow of wastewater, and therefore, continuous treatment is desired so that each part of the waste steam is treated.

This single pass lagoon system will become more and more closed as, and wastewater temperatures will typically increase, as for instance, 50% of the effluent is reused, 60% of the effluent is reused, 80% of the effluent is reused, 90% of the effluent is reused, and potentially 100% of the effluent is reused. As the level of closure increases the temperature of the wastewater will increase.

An embodiment of a wastewater treatment plant in which embodiments of the present inventions, including the embodiments of the examples, can be used is an activated sludge system, in this system the influent, which can be the wastewater from an industrial process is delivered to a primary clarifier in which solids are allowed to settle. The wastewater then passes to an aerated basin, and then to a secondary clarifier where sludge is recycled to pass through the aerated basin again. Due to the recycling in the activated sludge system, a holding tank is not necessary, although it may be desired as a back up. This system will become more and more closed as, and wastewater temperatures will typically increase, as for instance, 50% of the effluent is reused, 60% of the effluent is reused, 80% of the effluent is reused, 90% of the effluent is reused, and potentially 100% of the effluent is reused. As the level of closure increases the temperature of the wastewater will increase.

Embodiments of the present inventions find use in wastewater treatment systems for use in conjunction with an industrial facility, using water in its processing or manufacturing of products or materials, such as a paper mill, pulp mill or both. In general, embodiments of the present thermophilic treatment methods and systems provide solutions that allow, among other things, a manufacturing industry, such as the pulp and paper industry, to achieve one or more and all of: reduced energy costs; increased water conservation; and increased water recycling and reuse. Further, these embodiments of the present thermophilic treatment methods and systems provide solutions that provides cost-effective, efficacious or both, wastewater treatment system and processes that operate in the range of about 35-70° C. (95-158° F.), which means a shift away from mesophilic biological treatment to thermophilic biological treatment, two stage treatment processes thermophilic followed by mesophilic, not relying on the biology developing naturally, using additives to specifically drive the treatment process, and combinations and variations of these. Further, these embodiments of the present thermophilic treatment methods and systems clean the wastewater for disposal, clean the wastewater for recycle or reuse, produce a saleable byproduct, and combinations and variations of these.

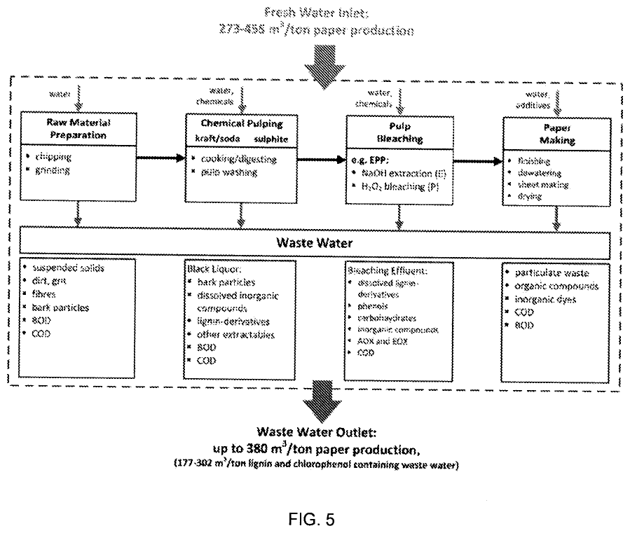

The sources of wastewater, in the pulp and paper industry are summarized in FIG. 5. It should be noted that “influent” as used in the FIG. 5 is water flowing into the pulp or paper making process for use in that process. The “influent” of FIG. 5, can be fresh water, but typically comprises from 20% to 100% effluent from the wastewater treatment plant associated with the pulp or paper mill.

The thermophiles (e.g., thermophilic microbes, thermophilic cultures) that are useful in embodiments of the present inventions, including the examples, are thermophiles from the Genera of Table 1. Examples of specific thermophiles for use in the present embodiments, including the examples, are set forth in Table 2. One or more than one, and combinations of, these thermophiles can be used in embodiments of the present thermophilic treatment methods and systems, including the examples.

TABLE 1
Thermophiles from the Genera
Thermococcus
Thermus
Bacillus
Bacillus
Bacillus
Thiosphera
Lactobacillus
Lactobacillus
Lactobacillus brueckii
Alicyclobacillus
Alicyclobacillus
Alicyclobacillus
Clostridium
Clostridium
Bidobacteria
Streptomyces
Brevibacillus

TABLE 2
EXAMPLES OF THERMOPHILES

| GENERA | SPECIES |
|---|---|
| Thermococcus | kodakarensis, |
| Thermus | aquaticus |
| Bacillus | stearothermophilus |
| Bacillus | flavotehrmus |
| Bacillus | licheniformis |
| Thiosphera | pantotropha |
| Lactobacillus | helviticus |
| Lactobacillus | delbrueckii |
| Lactobacillus brueckii | Sub species bulgaricus |
| Alicyclobacillus | acidoterrestris |
| Alicyclobacillus | disulfidooxidans |
| Alicyclobacillus | sacchari |
| Clostridium | clariflavum |
| Clostridium | butyricum |
| Bidobacteria | lactis |
| Streptomyces | thermopholis |
| Brevibacillus | laterosporus |

A full list of thermophilic cultures is contained in Bergey's Manual of Determinative Bacteriology, by John. G. Holt, Ph.D., Ninth Edition ISBN-13: 978-0683006032 incorporated herein by reference. One or more than one and combinations of these thermophilic microbes (e.g., cultures), can be used in embodiments of the present thermophilic treatment methods and systems, including the present examples. Industrial thermophilic cultures and cultures thriving at temperatures above the optimum for mesophiles of 35° C. (95° F.) for wastewater treatment, include among others, Streptococcus thermophilus, Lactobacillus helveticus, Lactobacillus bulgaricus, Thiosphera pantotropha and Bacillus subtills and various other Bacillus species suitable for thermophilic applications.

It should be noted that any non-pathogenic microbe that has an optimum growth temperature above 35° C. (95° F.), and preferably an optimum growth temperature in the range of 40-42° C. (104-197.6° F.), could be used in the present thermophilic treatments and for the present high temperature wastewater treatment systems and methods, unless its use is unacceptable for some other reason, and the term thermophile as used herein is intended to include such microbes.

In general, for the present systems and methods to treat high temperature wastewater, including the various embodiments and examples, batch or continual addition of thermophilic microbes can be used. Further, for either batch or continual addition methods, the thermophiles can be grown by growing thermophilic cultures in: a side stream reactor such as a Biofermentor for addition to the wastewater system; on-site, off-off site and transported to the site, and combinations and variations of these. The thermophiles are preferably grown in a biofermentation system, such as a Biofermentor, embodiments of which are taught and disclosed in U.S. Pat. Nos. 7,879,593 and 9,409,803, the entire disclosure of each of which is incorporated herein by reference.

Thus, for example, batch or continual addition of thermophilic microbes by growing these cultures in a side stream reactor such as a Biofermentor could be used to enhance treatment (hereinafter referred to as “Seeding Program”) during the warmer months in for example a single pass lagoon system. It would be advantageous for the thermophile seeding program coupled with a reseeding program of mesophilic microbes downstream of the influent after cooling has occurred to take advantage of the higher activity of mesophiles as the temperature drops. This approach can be used to provide the thermophilic treatments of any of the Examples.

Thus, for example, batch or continual addition of thermophilic microbes by growing these cultures in a side stream reactor such as a Biofermentor could be used to enhance a high temperature activated sludge system. It is noted that with activated sludge plants temperature becomes more of a problem as the heat has less area or volume to dissipate, which means that reactor temperatures are generally above 35° C. (95° F.). This promotes filamentous microbes that do not settle. In the pulp and paper industry, typical activated sludge plant, biological reactor temperatures operate at 37.7+° C. (100+F), which coupled with an effluent with highly soluble Biochemical Oxygen Demand (BOD)/organic wood sugars promotes ideal conditions for severe filamentous growth/settleability issues and potential of fecal coliforms

Generally, batch or continual addition of non-filamentous, non-pathogenic thermophilic microbes by growing these microbes in a reactor, by growing them off site and transporting them to the site, by a side-stream reactor, such as a biofermentation system could be used to enhance settleability and out-compete fecal bacteria promoting a better settling biomass with less pathogens. If necessary, this could be coupled with a mesophilic program thereby re-seeding non-pathogenic mesophilic microbes to increase activity as the temperature falls into the lower less active range for thermophilic microbes allowing better performance over a range of seasonal operating temperatures. A better settling biomass would result in elimination of any organic or inorganic settling aids in the secondary clarifier (such as polymers or ferric sulfate), better BOD and suspended solids removal along with lower fecal in the effluent and lower dewatering costs reducing the overall OPEX costs of the system.

For example, some of the challenges specifically for the pulp and paper industry continue to be around water usage, energy conservation, reduced carbon footprint and treatment of waste, whether it be fiber losses, total reduced sulfur (TRS) compounds resulting in malodorous air emissions, TRS discharged to the wastewater treatment system creating immediate dissolved oxygen demand (IDOD), foul condensate or general wastewater from the pulp mill, bleach plant or paper line. With the incoming wastewater streams exceeding 35-40° C. at best and perhaps as high as 50° C. as suggested above, the performance of mesophilic biological treatment is at best 20-40% of the optimum treatment resulting excessive operating costs, fecal contamination, and challenges meeting water discharge permit requirements. Embodiments of the present thermophilic treatments, methods and systems are used to mitigate and address these challenges.

For example, with Cluster rules requiring removal of total reduced sulfur compounds (TRS) and associated terpenes, methanol and other volatile organics, pulp and paper companies are opting for all hard-pipe options as the least expensive route for treatment adding 20-30% BOD load to the existing first section of the treatment plant, which based on regulatory guidelines must have a minimum amount of aeration to satisfy the oxygen demand. These systems are costly with a mix of hard-pipe options and recovery boilers with a price tag of around $300 million for each plant. The challenges for treatment of foul condensate are multiple:
(i) The effluent is sterile coming from the mill.
(ii) Associated compounds such as terpenes are toxic to the biology
(iii) The effluent is extremely hot 50-70° C. (not conducive for mesophilic treatment).
(iv) The effluent contains a high degree of reduced sulfur compounds such as hydrogen sulfide which are air pollutants and create IDOD
(v) The load is extremely high requiring more supplemental nutrients (nitrogen and phosphorus leading to more biosolids/sludge build up in the treatment system.
(vi) The models developed for the industry by NCASI all assume methanol is highly biodegradable and that in fact these pollutants are biodegraded not air stripped. In fact, this is a false assumption based on work carried out by ABS, which has shown no viable (mesophilic) biology in the first sections where hard pipe solutions have been implemented. This means that all the volatile organics are being air-stripped into the gaseous phase polluting the air we breathe.
   Further, the hard pipe option for foul condensate disposal increases the organic load to the wastewater treatment by 20-50%. Embodiments of the present thermophilic treatments, methods and systems are used to mitigate and address these challenges.

Furthermore, the requirement to remove lignin from wood requires large scale use of reducing agents in Kraft using sodium sulfide and sulfite mills using sodium sulfite results in large quantities of total reduced sulfur (TRS) compounds including but not limited to sulfide, dimethyl sulfide, dimethyl disulfide and methyl mercaptans. (By reference included herein: “REDUCED SULPHUR COMPOUNDS IN AMBIENT AIR AND IN EMISSIONS FROM WASTEWATER CLARIFIERS AT A KRAFT PULP MILL” by Chien Chi Victor Liang A Thesis Submitted in Conformity with the Requirements for the Degree of Master of Applied Science Department of Chemical Engineering and Applied Chemistry University of Toronto). These malodorous compounds plague the local population near a pulp and paper mill, which results in many public complaints and pressure on the industry to curb release to the environment or close the mill. Embodiments of the present thermophilic treatments, methods and systems are used to mitigate and address these challenges.

Hydrogen sulfide odors not only come from mill sources but also from wastewater treatment systems where sulfate reducing bacteria (SRB's) find a niche environment in pre-settling basins, of where sludge solids have built-up in lagoon systems forming anaerobic benthic activity. These bacteria reduce the sulfate rich wastewater (Often 100-400 mg/L) to hydrogen sulfide, which then enters the water column and gasses off. When water in the treatment system rich in hydrogen sulfide reaches an aerator, this causes further off-gassing of the hydrogen sulfide due to the turbulence in the water. Often the incoming wastewater from the mill has a high pH of 8-9, which keeps hydrogen sulfide in solution. Optimum biological treatment occurs at a pH range of 6.5 to 8.5 and effluent discharge guidelines often require pH 8 or less. Therefore, many paper mills add acid to lower the pH causing further gassing off of hydrogen sulfide. Embodiments of the present thermophilic treatments, methods and systems are used to mitigate and address these challenges.

Further, the pulp and paper industry have large sites covering many acres of land, wood chip piles, paper recycle storage areas and other open, potential pest infected areas, which results in coliform contamination from fecal matter. Large treatment ponds often attract migrant birds such as Canadian geese, which defecate in the water contaminating it with fecal matter. Many also discharge municipal wastewater from the workers directly into the industrial wastewater treatment systems or have separate municipal package plants which discharge the effluent into the industrial effluent treatment system. With these wastewater effluents being sterile for the most part, containing highly easily biodegradable wood sugars and in a more ideal temperature range (35-40° C.) for pathogenic bacteria such as Klebsiella and E. coli. Embodiments of the present thermophilic treatments, methods and systems are used to mitigate and address these challenges.

### Providing Treatment Batches of Thermophilic Microbes and Dosages

In general, for embodiments of the present systems and methods, including the Examples, the growing and providing of thermophilic microbes can be accomplished by growing a treatment batched in a reactor, a fermentation device or other type of device know and used for growing cultures of microbes. The device grows a culture of thermophilic microbes to provide a treatment batch of thermophilic microbes. The growing of the microbes to provide a treatment batch, can be done off-site and then transported to the wastewater treatment facility for application to the wastewater, or they can be grown on sight, and combinations and variations of these. The microbes can be grown to a provide a treatment batch by using a side-stream reactor, a biofermentation system, preferably by using an on-site device, reactor or biofermentation system. Examples of biofermentation systems and devices are disclosed and taught in U.S. Pat. Nos. 7,879,593 and 9,409,803, the entire disclosure of each of which is incorporated herein by reference. Preferably, the thermophiles are grown, held and transported within their optimal growth temperature range. Thus, in preferred embodiments all of the devices for growing, transporting and delivering the microbes to the waste water, (e.g., growing and delivering a treatment batch of thermophilic microbes) should be configured to handle the higher temperatures (50° C. (122° F.) to 70° C. (158° F.) that are preferably used for growth, transportation and delivery of a treatment batch of thermophilic microbes to a wastewater system.

Generally, for embodiments of the present systems and methods, including the Examples, the dosing rates (gallons per week) of the thermophilic microbes can be for the addition of a dosing liquid (e.g., a treatment batch) of from about 0.025 gallons (100 mL) to 500 gallons, about 100 gallons, about 200 gallons, about 300 gallons, from about 50 gallons to about 600 gallons per week, from about 100 gallons to about 500 gallons per day, from about 300 gallons to about 900 gallons per day, from about 500 gallons to about 1,000 gallons per day, and larger and smaller amounts (depending among other things on the size of system and load on the system), as well as, all values within these ranges. The dosing rates for the activated sludge and digester can be the same or different, they can be added at the same time, or at different times, they can be added periodically or continuously. The rates of addition can change over the course of the process.

Generally, for embodiments of the present systems and methods, including the Examples, the concentration or amount of thermophilic microbes in the dosing liquid (e.g., a treatment batch) can vary over a range that is needed to meet the requirements of the system. Thus, for example, the thermophilic microbe containing liquid can have from about 10² cfu/ml to 10¹³ cfu/ml, 10³ cfu/ml to 10⁸ cfu/ml, 10⁶ cfu/ml to 10⁸ cfu/ml, 10⁷ cfu/ml to 10¹¹ cfu/ml, greater than 10³ cfu/ml, greater than 10⁸ cfu/ml, greater than 10⁹ cfu/ml, and about 10⁵ cfu/ml to about 10¹³ cfu/ml, about 10⁶ cfu/ml to 10¹² about cfu/ml, 10⁸ cfu/ml to 10¹². The thermophilic microbe containing liquid having from about 10⁻¹¹ g/ml of microbes to about 10⁻¹ g/ml of microbes, about 10⁻⁸ g/ml of microbes to about 10⁻² g/ml of microbes, and about 10⁻⁴ g/ml of microbes to about 10⁻¹ g/ml of microbes. These calculations are based on 1 gram dry weight thermophilic microbe being equivalent to 10-13 cfu/mL for larger thermophilic microbes these weights can have ranges from 10× greater, to 100× greater to 1000× greater or smaller microbes have ranges of 10⁻¹ to 10⁻² to 10⁻³ are contemplated.

Generally, for embodiments of the present systems and methods, including the Examples, these systems and methods for waste water treatment can have one or more of the following features: where the thermophilic microbes are added as part of a liquid the thermophilic microbe containing liquid can have from about 10² cfu/ml to 10¹³ cfu/ml, 10³ cfu/ml to 10⁸ cfu/ml, 10⁶ cfu/ml to 10⁸ cfu/ml, 10⁷ cfu/ml to 10¹¹ cfu/ml, greater than 10³ cfu/ml, greater than 10⁸ cfu/ml, greater than 10⁹ cfu/ml, and about 10⁵ cfu/ml to about 10¹³ cfu/ml, about 10⁶ cfu/ml to 10¹² about cfu/ml, 10⁸ cfu/ml to 10¹². The thermophilic microbe containing liquid having from about 10⁻¹¹ g/ml of thermophilic microbes to about 10⁻¹ g/ml of thermophilic microbes, about 10⁻⁸ g/ml of microbes to about 10⁻² g/ml of thermophilic microbes, and about 10⁻⁴ g/ml of thermophilic microbes to about 10⁻¹ g/ml of thermophilic microbes. These calculations are based on 1 gram dry weight thermophilic microbe being equivalent to 10⁻¹³ cfu/mL for larger microbes these weights can have ranges from 10× greater, to 100× greater to 1000× greater or smaller thermophilic microbes have ranges of 10⁻¹ to 10⁻², 10⁻¹ to 10⁻³.

Generally, for embodiments of the present systems and methods, including the Examples, the method includes depositing an inoculum comprising a culture of thermophilic microbes into a device for growing the thermophilic microbes the inoculum can have a starting concentration of 10³ cfu/ml to 10⁸ cfu/ml. The inoculum is then grown to provide a treatment batch (e.g. dosing liquid) having the thermophilic microbes in a concentration of 10⁶ cfu/ml to 10¹⁰ cfu/ml, and higher. The treatment batch is then applied, preferably directly applied, to the higher temperature wastewater in the wastewater facility to provide a thermophilic microbe concentration in the wastewater of at least 10³ cfu/ml wastewater, at least 10⁴ cfu/ml wastewater, at least 10⁶ cfu/ml wastewater, from about at least 10³ cfu/ml wastewater to about at least 10⁷ cfu/ml wastewater, and from about from about at least 10⁴ cfu/ml wastewater to about at least 10⁵ cfu/ml wastewater.

Generally, for embodiments of the present systems and methods, including the Examples, the methods include providing an effective concentration of thermophilic microbes at a point of application in the wastewater treatment facility sufficient to significantly treat the higher temperature wastewater at the application point. Optimally, the inoculum is grown to a concentration of about 10⁷-10¹¹, about 10⁸, about 10⁹, about 10¹⁰, 10⁹-10¹⁰, 10⁸-10⁹, and 10⁷-10⁸ colony forming units per milliliter (cfu/ml) and greater and smaller concentrations, and then directly applied to the high temperature wastewater to achieve a preferred minimum dosage of about 10³ cfu/ml of wastewater at the point of application; about 10³ cfu/ml of wastewater at the point of application at least 10⁶ cfu/ml wastewater, from about at least 10³ cfu/ml wastewater to about at least 10⁷ cfu/ml wastewater, and from about from about at least 10⁴ cfu/ml wastewater to about at least 10⁵ cfu/ml wastewater.

Wastewater treatment plants can range from small volumes per day, measures in flow per day, i.e., gallons per day (GPD) to large volumes measured in flows of million (1,000,000) gallons per day (MGD). The flow can be 10s, 100s, 1,000s, 10,000s, and 100,000s of GPD. Typically, for municipal and industrial sites, the flow of wastewater can range from about 0.5 MGD and greater, about 0.8 MGD and greater, about 1 MGD and greater, about 2 MGD and greater, about 5 MGD and greater, from about 0.3 MGD to about 60 MGD, from about 0.5 MGD to about 2 MGD, from about 2 MGD to about 60 MGD, from 1 MGD to 100 MGD, from 5 MGD to 50 MGD, from about 1 MGD to about 15 MGD, from about 5 MGD to about 25 MGD, from about 10 MGD to about 40 MGD, from about 20 MGD to about 50 MGD, from about 25 MGD to about 60 MGD, from about 200 MGD to about 300 MGD, and greater and smaller, flows as well as, all flows within these ranges.

Further, it is understood that the volume of dosing liquid required, the dossing rate, the concentration of thermophilic microbes in the dossing liquid, the effective concentration of the thermophilic microbes required, and the volume of wastewater to be treated can be, and typically are interdependent. Thus, combinations and variations of the forgoing dossing rates, concentrations of thermophilic microbes in the dossing liquid, effective concentrations of the thermophilic microbes required, and the volume of wastewater (size of treatment plant) are contemplated by the present inventions and form embodiments of the present thermophilic systems and methods.

Further, the optimal numbers provided here, of the thermophilic microbes being grown to a concentration of approximately 10⁹-10¹⁰ or 10⁸-10⁹ or 10⁷-10⁸ cfu/ml, and of achieving at least about 10³ cfu/ml at the point of application, are based on thermophilic microbes currently used and commonly known. It being understood, that potentially, as thermophilic microbes are discovered that are more efficient in degrading contaminants, lower levels of those microbes may be required.

### EXAMPLES

The following examples are provided to illustrate various embodiments of the present systems and methods of the present inventions. These examples are for illustrative purposes, may be prophetic, and should not be viewed as limiting, and do not otherwise limit the scope of the present inventions.

### Example 1

### Single Pass Lagoon: Anaerobic-Aerobic: Ammonium Sulfite Mill—Loss of Treatment in Colder Months

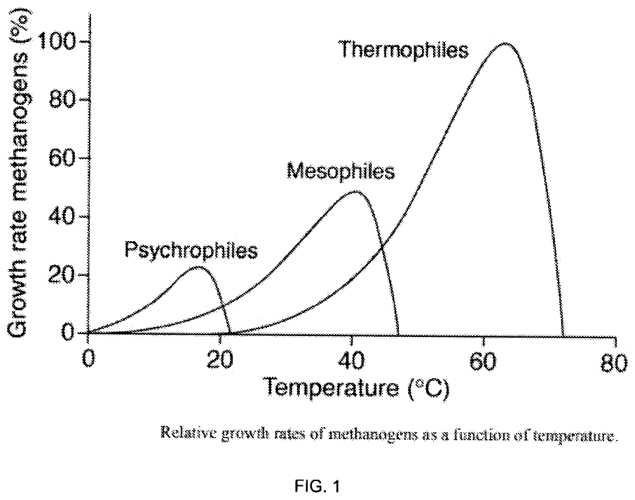

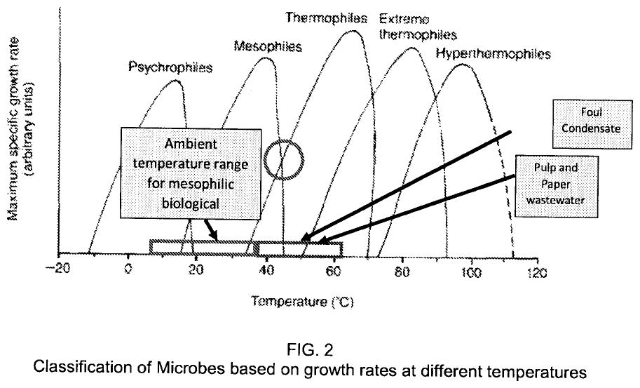

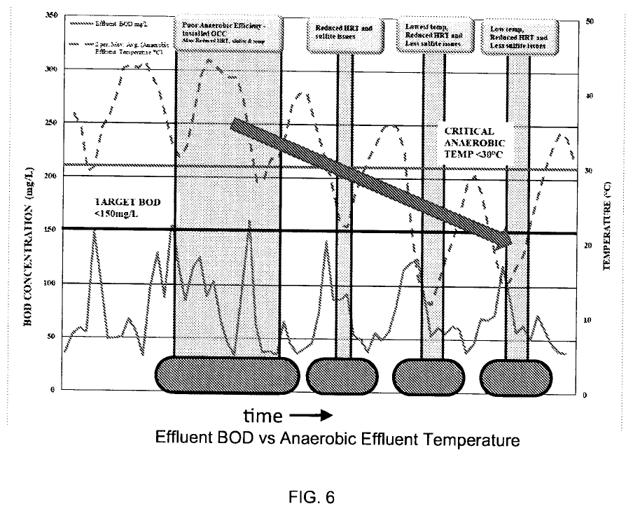

An ammonium sulfite mill suffers from loss of aerobic biological treatment efficiency during the winter months as shown in FIG. 6. For an extended period, colder winter temperatures and short-circuiting due to solids build-up was used to explain this challenge. To address this situation modifications to the anaerobic system to minimize short-circuiting by installing an above ground, pump-around system, are implemented. However, these modifications are ineffective and make the situation worse due to further temperature losses leading to a massive upset/compliance issue for the treatment facility. Upon examination of the impact of temperature on anaerobic mesophilic (methanogenic) treatment shown in FIG. 1 or general mesophile activity shown in FIG. 2, there appears to be no reason for this drop in the effectiveness of the anaerobic or aerobic treatment system. It was discovered that this phenomenon is caused by loss of treatment of sulfite in the preceding anaerobic lagoons caused by the temperature falling below 30-32° C. resulting in an increase in sulfite concentrations of greater than 50-100 mg/L which are toxic to aerobic treatment. It is theorized that this loss of activity would only result due to thermophilic anaerobic bacterial activity such as sulfate reducing bacteria (SRBs).

A pre-treatment system is then installed to the anaerobic pond, which is called the OCC pond, which was seeded with an anaerobic biomass from a brewery. Since the installation the anaerobic effluent temperature has fallen significantly by about 10° C. from a peak of 40-45° C. to 30-35° C. as shown in FIG. 6.

To address this situation an embodiment of thermophilic treatment is implemented to supplement the anaerobic treatment system with thermophilic anaerobic bacteria such as SRB's to reduce sulfite to hydrogen sulfide and thereby minimize the need to feed of mesophilic bacteria to the aeration basin and provide blowers for aeration to minimize the impact of sulfite.

The devices for providing a dosing liquid of thermophilic microbes and dosage rates and amounts of the thermophilic microbes can be any of those set forth in the “Providing Treatment Batches of Thermophilic Microbes and Dosages” section of this Specification.

This Example also demonstrates the importance of influent wastewater temperature and the impact of seasonal weather changes and temperature loss across large surface areas or pipes bypassing flow in lagoon systems.

### Example 2

### Single Pass Lagoon: Kraft Mill—with Evaporators

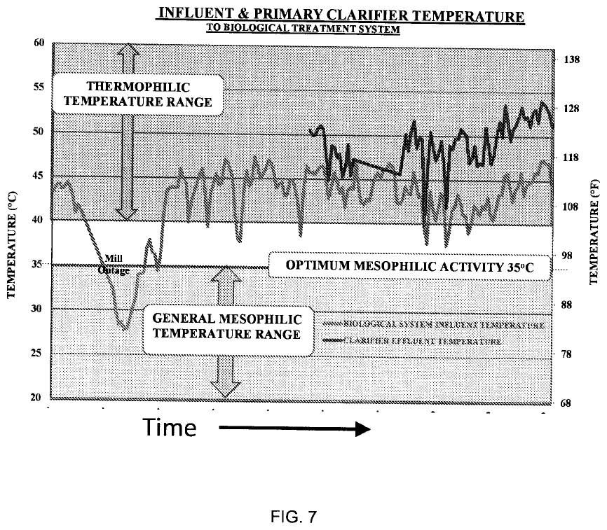

In a kraft mill having a daily flow of about 25-30 MGD and operating an aerated stabilization basin (ASB). Mill water loop closures saving 4-6 MGD caused wastewater temperatures to increase significantly resulting in influent temperatures from the clarifier of 45-54° C. (100-130° F.) with temperatures entering the ASB exceeding 35° C. (95° F.) as shown in FIG. 7.

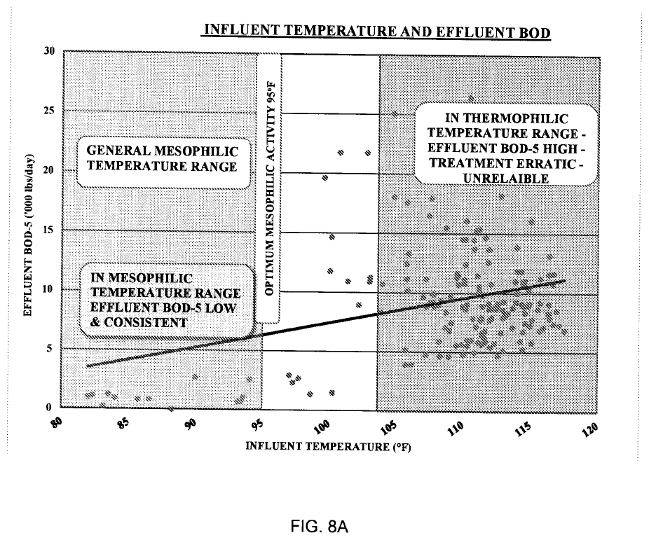

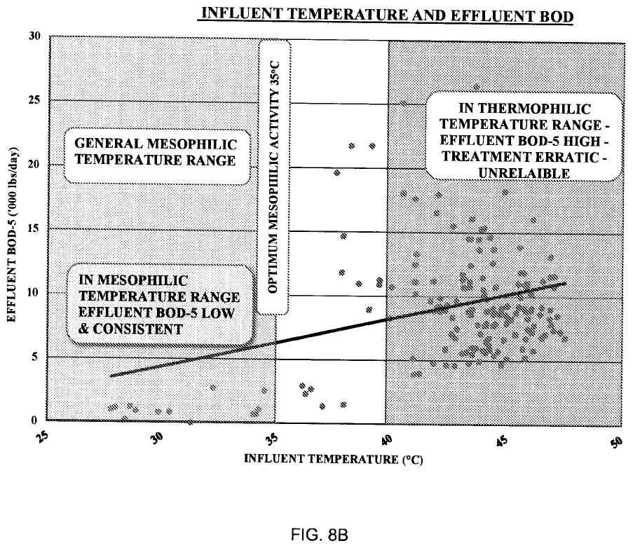

The increased influent temperature to secondary treatment results in a decrease in treatment efficiency and hence higher effluent BOD-5 from the treatment system as shown in FIGS. 8A and 8B. Temperatures exceeding the mesophilic optimum of 35° C. (95° F.) cause high effluent BOD-5, unstable and erratic treatment because the mesophilic microbial activity drops off

Ahead of the aerated stabilization basin (single pass lagoon) are two pre-settling basins, which generate significant amounts of hydrogen sulfide from sulfate in the wastewater, particularly as solids build-up. The highly biodegradable wood sugars, in an unaerated environment with high temperatures leads to the production of hydrogen sulfide by thermophilic sulfate reducing bacteria (SRB's).

To address this problem and minimize hydrogen sulfide production from sulfate is the addition of thermophilic microbes upstream to compete for organic food sources such as wood sugars. This reduces sulfide formation and hence malodors arising from the treatment system and odor complaints. Another benefit of this approach is to reduce immediate dissolved oxygen demand (IDOD) on the aeration basin caused by sulfides which chemically react with oxygen to form oxidized sulfur compounds such as sulfate. This chemical IDOD outcompetes essential oxygen required by aerobic bacteria to convert BOD to carbon dioxide and water as part of the treatment process.

The devices for providing a dosing liquid of thermophilic microbes and dosage rates and amounts of the thermophilic microbes can be any of those set forth in the “Providing Treatment Batches of Thermophilic Microbes and Dosages” section of this Specification.

To address this problem an approach is to add purple sulfur bacteria which convert hydrogen sulfide to sulfide granules, which requires sunlight for photosynthesis. Another sulfide reducing bacteria such as Paracoccus pantotropha, formerly Thiosphera pantotropha, which convert sulfide into elemental sulfur under anaerobic conditions without the need for sunlight. Again, the two main benefits being to reduce IDOD and emissions of malodors from the treatment system, while improving effluent quality for BOD, TSS, ammonia and phosphate.

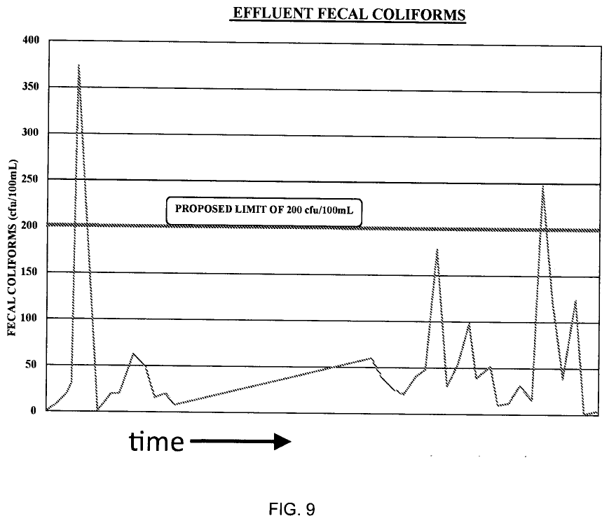

The higher influent and effluent temperatures in the range of 39-45° C. can also lead to fecal coliforms in the final effluent or growth of opportunistic pathogens such as Klebsiella sp. A snapshot of fecal coliforms discharged from the mill is shown in FIG. 9, which shows the mill generally within the proposed 200 cfu/100 mL monthly geometric mean. One solution to keep fecal coliforms within the proposed or permitted limits would be to feed thermophilic bacteria at the primary effluent and/or at the influent to the ASB to outcompete the fecal coliforms for organic or other nutritional food sources. These microbes could be fed as described above using a biofermentation systems, preferably an onsite biofermentation system, such as a Biofermentor®. Examples of biofermentation systems are disclosed and taught in U.S. Pat. No. 7,879,593, the entire disclosure of which is incorporated herein by reference.

### Example 3

### Single Pass Lagoon: Kraft Mill—Foul Condensate Hard-Pipe

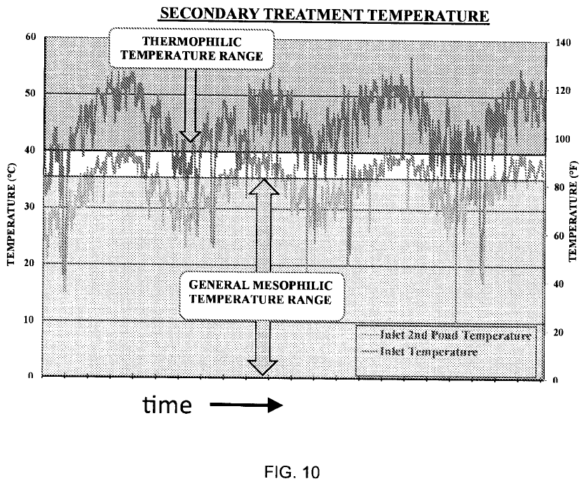

A mill in the Southeastern, USA uses the hard-pipe option for disposal of foul condensate under the “Cluster Rules”. The mill operates single pass lagoon with 3 parts: the first pond which receives the foul condensate, second pond and third pond. FIG. 10 shows the inlet temperature to the first Pond well above the mesophilic optimum of 35° C. at 40-55° C. for about 80+% of the year, while the second Pond is above 35° C. for approximately 6 months of the year.

Treatment of foul condensate by hard-pipe requires significantly more aeration to satisfy IDOD from reduced sulfur compounds and BOD oxygen demand and a reduction in oxygen transfer efficiency with aeration at higher temperatures. Other additional operating costs have been incurred by mills, such as additional supplemental nutrient (N&P) usually in the form of UAN and bioaugmentation products to support biological growth and activity. With lagoon systems and hard piped foul condensate, the additional BOD load and nutrient leads to greater biosolids production resulting in diminished hydraulic retention time (HRT) and a subsequent downward spiral in efficiency with an upward spiral in operating costs to offset poor treatment, until the mill is faced with compliance challenges and/or a massive economic expenditure to dredge at the same time.

Prior to use of the present thermophilic methods, the mill could spend millions of dollars per year on attempts to address this problem, including for example bioaugmentation products, supplemental nutrient (Urea ammonium nitrate or UAN), dredging and control of hyacinth growth due to excessive feeding of nutrients. It believed that these attempts will not be successful.

To address this problem, batch or continual addition of non-filamentous, non-pathogenic thermophilic microbes by growing these microbes in side-stream reactor, such as a biofermentation system could be used to treat the foul condensate in the hard pipe coupled with a pure oxygen feed along the pipeline to add oxygen on demand. Preferably, supplemental nutrient is not needed, or required.

The devices for providing a dosing liquid of thermophilic microbes and dosage rates and amounts of the thermophilic microbes can be any of those set forth in the “Providing Treatment Batches of Thermophilic Microbes and Dosages” section of this Specification.

To address this problem, in addition to the thermophilic approach, the pure oxygen could be added with the non-filamentous, non-pathogenic thermophiles into the treatment zone to provide oxygen for treatment, while minimizing air stripping of pollutants by aeration with air only being 20% oxygen versus pure oxygen being 99%.

In a further embodiment this could be coupled with a mesophilic program feeding non-pathogenic mesophilic microbes to increase activity as the temperature falls into the lower less active range for thermophilic microbes allowing better performance over a range of seasonal operating temperatures.

The benefits to a mill would be lower operating costs for aeration, supplemental nutrient and lower costs of dredging and sludge disposal, while making it possible to meet the new proposed phosphorus limits.

### Example 4

### Activated Sludge—High Temperature—Filamentous Bulking

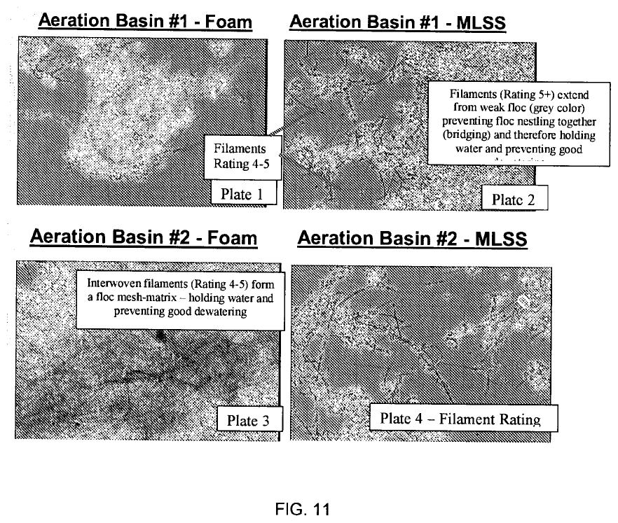

High influent wastewater temperatures exceedingly approximately 36-37.7° C. (98-100° F.) promote filamentous microbes and bulking as shown in the photomicrographs (FIG. 11 showing Plates 1-4) below from a kraft pulp mill activated sludge plant. The filamentous rating on a scale of 0-6 is rated at around 5-6: the worst it could be. This activated sludge plant has struggled with filamentous bulking since the early 1990's and continues to struggle to this day. The result of the filamentous microbes is poor settleability requiring application of polymer in the secondary clarifier to prevent solids being discharged in the effluent. The poor settleability leads to poor compaction, high recycle rates and low return activated sludge concentrations (RAS) and hence waste activated sludge (WAS) concentrations, which traditionally is taken off the RAS lines. Ultimately, the WAS goes to belt presses for dewatering. The poor dewaterability requires more polymer typically more than 18-20 lbs/ton of WAS. A good settling and dewaterable sludge should use 10-12 lbs/ton. This leads to additional time, manpower, polymer, and cost for dewatering along with equipment limitations and a dirty filtrate returning solids back to the head of the plant, which then must be removed a second or third time.

The increased operating costs caused by these microbiological conditions are significant running in to several million dollars in this example.

In a further embodiment of this example, to minimize the operating cost by feeding thermophilic microbes, or a mixture of thermophilic microbes with mesophilic, non-pathogenic, non-filamentous microbes, into the activated sludge system to create a shift in microbial population causing the biomass to settle more effectively. This would improve settleability and dewatering while minimizing the operating costs for nutrient, sludge dewatering, disposal and associated manpower, electrical power and polymer, which represents for a mill millions of dollars in annual savings, for instance the mill of this example has savings of $5+ million per annum.

The devices for providing a dosing liquid of thermophilic microbes and dosage rates and amounts of the thermophilic microbes can be any of those set forth in the “Providing Treatment Batches of Thermophilic Microbes and Dosages” section of this Specification.

### Example 5

### Activated Sludge (UNOX)—Foul Condensate Hard-Pipe—Filamentous Bulking

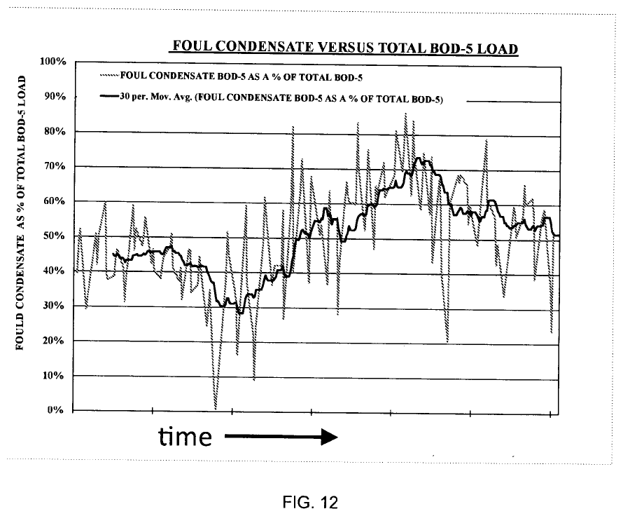

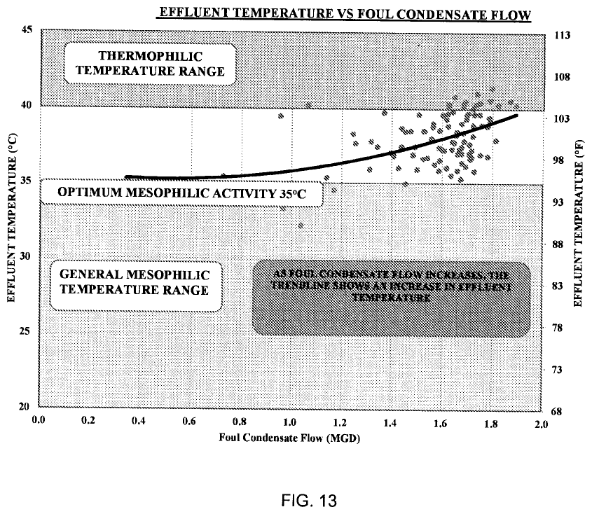

A mill treats foul condensate discharged directly to the first cell of a pure oxygen injection activated sludge plant. Foul condensate represents a significant organic load from the mill of 30-70% as shown in FIG. 12 and thermal load. FIG. 13 shows the thermal impact of increasing foul condensate flow on effluent temperature after treatment, which above 1 MGD pushes effluent temperatures above the mesophilic optimum of 35° C. (95° F.) reaching thermophilic ranges.

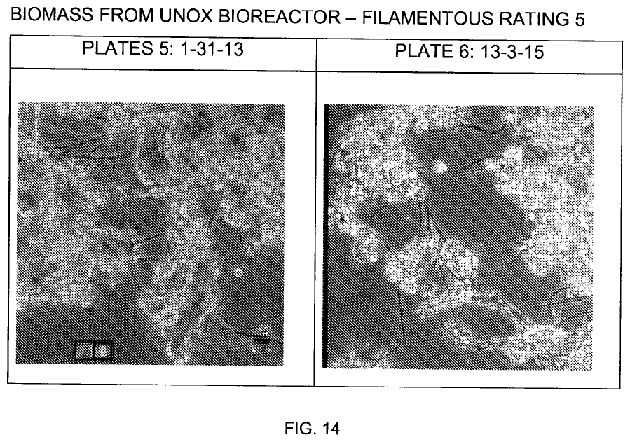

This resultant high temperature greater than 100° F. coupled with highly biodegradable methanol from foul condensate and wood sugars leads to serious filamentous bulking problems/poor biomass settleability as shown in FIG. 14 (Plates 5 & 6). This floc would be described as open, weak, with bridging preventing the flocs nestling close together and therefore preventing good settleability and compaction into a dense biomass that can be recycled from the secondary clarifier. This means that recycle rates need to be increased and hence retention time in the biological reactor (Bioreactor) decreases adversely impacting treatment. This creates all the same challenges described in Example 4 resulting in excessive operating costs.

One solution to minimize the operating cost by feeding thermophilic, or a mixture of thermophilic microbes with mesophilic, non-pathogenic, non-filamentous microbes using a Biofermentation system into the activated sludge system to create a shift in microbial population causing the biomass to settle more effectively. This would improve settleability and dewatering while minimizing the operating costs for nutrient, sludge dewatering, disposal and associated manpower, electrical power, and polymer, which represents for this mill $5+ million per annum.

The devices for providing a dosing liquid of thermophilic microbes and dosage rates and amounts of the thermophilic microbes can be any of those set forth in the “Providing Treatment Batches of Thermophilic Microbes and Dosages” section of this Specification.

### Example 6

### Kraft Mill—Fecal Coliforms in the Effluent

In this example, the mill has a cooling tower system preceding an activated sludge plant which tends to be a perfect environment for growth of undesirable and pathogenic microbes. As in common with all prior mentioned mills, the incoming wastewater temperatures were generally 100-120° F. depending on the efficiency of the cooling tower. This high temperature leads to filamentous microbes in the activated sludge plant as described in Example 5, which also explains all the challenges related to poor settleability, lower return activated sludge concentrations (RAS) and high waste activated sludge rates and poor dewaterability. These conditions result in high costs of dewatering and disposal.

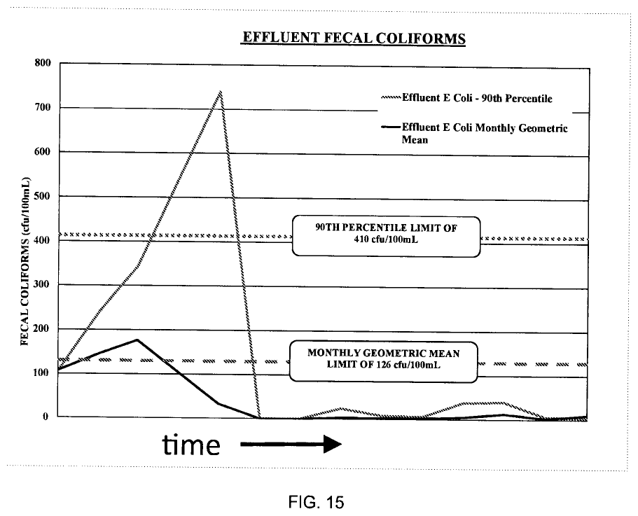

In this example, the cooling tower and activated sludge system become infested with pathogenic bacteria including Klebsiella sp. and E. coli leading to the need to disinfect the final effluent with a discharge flow of about 40 MGD. The cost of disinfection can range from $300-500/d/MGD, which is a significant operational cost with results shown in FIG. 15.

One solution to eliminate or minimize the cost of disinfection is to cause a shift in microbial populations by feeding thermophilic and/or mesophilic, non-pathogenic, non-filamentous microbes into the cooling tower and/or the activated sludge system. Mesophiles would be fed at a point in the activated sludge plant where the temperature was 100-110° F. or lower. Thermophilies would be fed into the cooling tower or front of the aeration basin where temperatures were typically 100-140° F. and can be higher, including up to about 160° F. If growth of thermophilic bacteria in the cooling tower threatened structural collapse due to the weight of biomass formed, then the cooling tower could be bypassed directly to the wastewater treatment plant with thermophiles fed at the front of the system.

Batch or continual addition of non-filamentous, non-pathogenic thermophilic microbes by growing these microbes in side-stream reactor, such as a Biofermentor could be used to enhance settleability and out-compete fecal bacteria promoting a better settling biomass with less pathogens. If necessary, this could be coupled with a mesophilic program thereby re-seeding non-pathogenic mesophilic microbes to increase activity as the temperature falls into the lower less active range for thermophilic microbes allowing better performance over a range of seasonal operating temperatures. A better settling biomass would result in elimination of any organic or inorganic settling aids in the secondary clarifier (such as polymers or ferric sulfate), better BOD and suspended solids removal along with lower fecal in the effluent and lower dewatering costs reducing the overall OPEX costs of the system.

The devices for providing a dosing liquid of thermophilic microbes and dosage rates and amounts of the thermophilic microbes can be any of those set forth in the “Providing Treatment Batches of Thermophilic Microbes and Dosages” section of this Specification.

### Example 7

### Power Plants—Cooling Towers—Pathogenic Biology

The challenge with continuing population growth is the need to expand power generation and to cool water using cooling towers. The steam electric industry in the USA uses 40-50% of the freshwater runoff according to “Bacterial Aerosols from Cooling Towers” by A. P. Adams, M. Garbett, H. B. Rees and B. G. Lewis Journal (Water Pollution Control Federation), Vol. 50, No. 10 (October, 1978), pp. 2362-2369 (8 pages), Published By: Wiley included herein by reference.

One of the largest public health and safety concerns in recent years is exposure to Legionella and other pathogenic microbial aerosols from cooling towers, which are required legally to receive some form of disinfection treatment. This could be chlorination, UV or other organic or inorganic biocides. These are all highly expensive solutions costing the industry millions of dollars a year.

This invention provides for feeding non-pathogenic thermophilic and/or mesophilic microbes into the water recirculation lines and cooling towers to consume organic matter and compete against pathogenic microbes preventing the pathogenic microbes from growing or gaining a foothold and establishing a sufficiently concentrated population that it becomes a Public Health concern versus adding chemicals to achieve the same goal.

The devices for providing a dosing liquid of thermophilic microbes and dosage rates and amounts of the thermophilic microbes can be any of those set forth in the “Providing Treatment Batches of Thermophilic Microbes and Dosages” section of this Specification.

### Example 8

In a lagoon system, including the system of FIG. 4, and a single pass lagoon system, such as in Examples 2 and 3, the dose of thermophilic microbes at the point of application is preferably at least about 10⁴ cfu/ml of wastewater. The concentration of microbes to high temperature wastewater at the point of application may be from about 10³ to 10⁸ cfu/ml, about 10⁵ to 10⁸ cfu/ml, about 10⁶ to 10⁸ cfu/ml, about 10⁷ to 10⁸ cfu/ml, and about 10⁴ to 10⁷ cfu/ml, 10⁴ to 10⁶ cfu/ml, and about 10⁴ to 10⁵ cfu/ml and higher. The concentration of thermophilic microbes in the dosing liquid (e.g., treatment batch) is preferably about 10⁹ to 10¹⁰ cfu/ml and higher. The concentration of thermophilic microbes in the dosing liquid may be about 10⁸ cfu/ml, or about 10⁷ cfu/ml, about 10⁶ cfu/ml, and higher. Depending on the dose of the thermophilic microbes, it may be possible to see a turn around in a lagoon system, such as a single pass lagoon system, within about 5-7 days, or within less than about 5 days, or within less than about 4 days, or within less than about 3 days, or within less than about 2 days, or within about I day, or within the residency time of the lagoon system.

### Example 9

In an activated sludge system, such as in Examples 4 and 5, and FIG. 3, the dose of thermophilic microbes at the point of application is optimally at least about 10⁴ cfu/ml wastewater. The concentration of thermophilic microbes to high temperature wastewater at the point of application may be from about 10³ to 10⁸ cfu/ml, about 10⁵ to 10⁸ cfu/ml, 10⁶ to 10⁸ cfu/ml, 10⁷ to 10⁸ cfu/ml, about 10⁴ to 10⁷ cfu/ml, about 10⁴ to 10⁶ cfu/ml, and about 10⁴ to 10⁵ cfu/ml. The concentration of thermophilic microbes in the dosing liquid is preferably about 10⁹ to 10¹⁰ cfu/ml and higher. The concentration of thermophilic microbes in the high temperature wastewater may be about 10⁸ cfu/ml, or about 10⁷ cfu/ml, about 10⁶ cfu/ml. Depending on the dose of the thermophilic microbes, it may be possible to see a turn around in an activated sludge system within about 5-7 days, or within less than about 5 days, or within less than about 4 days, or within less than about 3 days, or within less than about 2 days, or within about 1 day, or in less than 1 day.

### Example 10

Digestion and disposal of primary or secondary biosolids in municipal wastewater treatment can represent 30-40% of the operating cost of a wastewater treatment system. Modern sustainable, engineering solutions such as the CAMBI process a process claimed to be carbon neutral seek to liquefy the solids prior to mesophilic anaerobic digestion to make methane, which means cooling the wastewater prior to the mesophilic digestion process. This invention solves the problem of cooling prior to treatment by using thermophilic methanogens and the associated acidogens to break down the complex organics to acetate which can be used by methanogens, which would further reduce the carbon footprint of the digestion process with energy recovery after production of methane. Methane production would be enhanced while the footprint would be reduced.

### Example 11

Aerobic digestion of the biosolids mentioned in Example 9 is also often approached aerobically using autothermal thermophilic aerobic digestion, which are highly energy intensive processes requiring extreme aeration and energy. Thermophilic organisms are allowed to develop naturally, which has resulted in filamentous thermophiles developing with all the subsequent operating challenges and costs mentioned in Example 4 and 5. This invention allows for feeding of a non-filamentous non-pathogenic thermophilic population to improve the digestion process and minimize filamentous organisms creating a poor dewatering biomass/sludge, hence reducing operating costs significantly.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments set forth in this specification, including dosing amounts and rates, microbe addition points, may be used with each other, in any one or more of the examples, in any one or more of the embodiments and in different and various combinations. Thus, for example, the configurations provided in the various embodiments of this specification may be used with each other; and the scope of protection afforded the present inventions should not be limited to a particular embodiment, configuration or arrangement that is set forth in a particular embodiment, example, or in an embodiment in a particular Figure.

The invention may be embodied in other forms than those specifically disclosed herein without departing from its spirit or essential characteristics. The described embodiments are to be considered in all respects only as illustrative and not restrictive.

What is claimed:

1. A method of treating a high temperature wastewater stream, the method comprising:
a. in a wastewater treatment system having an influent stream of wastewater containing pollutants, the wastewater treatment system comprising a first treatment device, and a second treatment device; wherein the wastewater flows from the first treatment device to the second treatment device;
b. adding a plurality of thermophilic microbes to the high temperature wastewater in the wastewater treatment system at a controlled and predetermined dosing rate; the microbes selected to remove the pollutants from the high temperature wastewater; the plurality of thermophilic microbes containing from about 10³ cfu/ml to 10¹³ cfu/ml.

2. The method of claim 1, wherein the pollutants in the wastewater are reduced providing an effluent having pollutants as measured by DOD and TSS reduced by at least about 50% from the influent wastewater stream.

3. The method of claim 1 or 2, wherein the pollutants in the wastewater are reduced providing an effluent having pollutants as measured by DOD and TSS reduced by at least about 90% from the influent wastewater stream.

4. The method of claim 1, 2 or 3, wherein the wastewater treatment plant has a throughput of about 10,000 GPD to about 500,000 GPD.

5. The method of claim 1, 2 or 3, wherein the wastewater treatment plant has a throughput of about 0.5 MGD to about 2 MGD.

6. The method of claim 1, 2 or 3, wherein the wastewater treatment plant has a throughput of about 2 MGD to about 60 MGD.

7. The method of claim 1, 2 or 3, wherein the wastewater treatment plant has a throughput of about 20 MGD to about 100 MGD.

8. The method of claim 1, 2 or 3, wherein the wastewater treatment plant has a throughput of about 2 MGD and greater.

9. The method of claim 1, wherein the thermophilic microbes are added to the first treatment device.

10. The method of claim 1, wherein the thermophilic microbes are added to the second treatment device.

11. The method of claim 1, wherein the wastewater treatment system comprises a third treatment device; wherein the wastewater flows from the second treatment device to the third treatment device.

12. The methods of any of claim 11, wherein the thermophilic microbes are added to the third treatment device.

13. The methods of claim 11, wherein the microbes are added to the second and third treatment devices; whereby the dose rate is cumulative of a dose rate for each treatment device.

14. The method of claim 1, wherein the influent wastewater stream has a temperature of greater than 35° C. (95° F.).

15. The method of claim 1, wherein the influent wastewater stream has a temperature of about 37° C. (98.6° F.) and greater.

16. The method of claim 1, wherein the influent wastewater stream has a temperature of about 41° C. (105.8° F.) and greater.

17. The method of claim 1, wherein the influent wastewater stream has a temperature of from 37° C. (98.6° F.) to about 55° C. (131° F.)

18. The method of claim 1, wherein an ambient air temperature at the wastewater treatment system is greater than 15° C. (59° F.).

19. The method of claim 1, wherein an ambient air temperature at the wastewater treatment system is about 30° C. (86° F.) and greater.

20. The method of claim 1, wherein an ambient air temperature at the wastewater treatment system is from about 27° C. (80.6° F.) to 39° C. (102.2° F.)

21. The method of claim 1, wherein mesophilic microbes are added to the wastewater.

22. The method of claim 21, wherein a temperature of the wastewater at a point of addition of the mesophilic microbes is at least 5° C. (25° F.) cooler than the temperature of the influent wastewater stream.

23. The method of claim 21, wherein a temperature of the wastewater at a point of addition of the mesophilic microbes is at least 10° C. (50° F.) cooler than the temperature of the influent wastewater stream.

24. The method of claim 21, wherein a temperature of the wastewater at a point of addition of the mesophilic microbes is at least 15° C. (59° F.) cooler than the temperature of the influent wastewater stream.

25. The method of claim 21, wherein a temperature of the wastewater at a point of addition of the mesophilic microbes is at least 20° C. (68° F.) cooler than the temperature of the influent wastewater stream.

26. The method of claim 21, wherein a temperature of the wastewater at a point of addition of the mesophilic microbes is at least 5° C. (25° F.) cooler than the temperature of the wastewater at a point of addition of the thermophilic microbes.

27. The method of claim 21, wherein a temperature of the wastewater at a point of addition of the mesophilic microbes is at least 10° C. (50° F.) cooler than the temperature of the influent wastewater stream.

28. The method of claim 21, wherein a temperature of the wastewater at a point of addition of the mesophilic microbes is at least 15° C. (59° F.) cooler than the temperature of the influent wastewater stream.

29. The method of claim 21, wherein a temperature of the wastewater at a point of addition of the mesophilic microbes is at least 20° C. (68° F.) cooler than the temperature of the influent wastewater stream.

30. A method of treating a high temperature wastewater stream, the method comprising:
a. in a wastewater treatment system having an influent stream of wastewater containing pollutants, the wastewater treatment system comprising a first treatment device, a second treatment device a third treatment device and a fourth treatment device;
b. adding a plurality of thermophilic microbes to the high temperature wastewater in the wastewater treatment system at a controlled and predetermined dosing rate; the microbes selected to remove the pollutants from the high temperature wastewater; the plurality of thermophilic microbes containing from about 10³ cfu/ml to 10¹³ cfu/ml;
c. wherein the first treatment device comprises screens and a girt chamber, where by large particles, plastic and girt are removed from the wastewater;
d. wherein the second treatment device comprises a basin;
e. wherein the third treatment device comprises a settling tank; wherein a return stream comprising an activated sludge is flowed to the second treatment device; wherein the effluent is flowed from the third treatment device;
f. wherein the fourth treatment device comprises a holding tank; wherein sludge from the third treatment device is flowed to the fourth treatment device; wherein the sludge is thickened.

31. The method of claim 30, wherein the pollutants in the wastewater are reduced providing an effluent having pollutants as measured by DOD and TSS reduced by at least about 50% from the influent wastewater stream.

32. The method of claim 30 or 32, wherein the pollutants in the wastewater are reduced providing an effluent having pollutants as measured by DOD and TSS reduced by at least about 90% from the influent wastewater stream.

33. The method of claim 30, 31 or 32, wherein the wastewater treatment plant has a throughput of about 10,000 GPD to about 500,000 GPD.

34. The method of claim 30, 31 or 32, wherein the wastewater treatment plant has a throughput of about 0.5 MGD to about 2 MGD.

35. The method of claim 30, 31 or 32, wherein the wastewater treatment plant has a throughput of about 2 MGD to about 60 MGD.

36. The method of claim 30, 31 or 32, wherein the wastewater treatment plant has a throughput of about 20 MGD to about 100 MGD.

37. The method of claim 30, 31 or 32, wherein the wastewater treatment plant has a throughput of about 2 MGD and greater.

38. The method of claim 30, wherein the thermophilic microbes are added to the first treatment device.

39. The method of claim 30, wherein the thermophilic microbes are added to the second treatment device.

40. The method of claim 30, wherein the thermophilic microbes are added to the third device.

41. The method of claim 30, wherein the thermophilic microbes are added to the fourth treatment device.

42. The method of claim 30, wherein the microbes are added to a plurality of the treatment devices; whereby the dose rate is cumulative of a dose rate for each treatment device.

43. The method of claim 30, wherein the influent wastewater stream has a temperature of greater than 35° C. (95° F.).

44. The method of claim 30, wherein the influent wastewater stream has a temperature of about 37° C. (98.6° F.) and greater.

45. The method of claim 30, wherein the influent wastewater stream has a temperature of about 41° C. (105.8° F.) and greater.

46. The method of claim 30, wherein the influent wastewater stream has a temperature of from 37° C. (98.6° F.) to about 55° C. (131° F.)

47. The method of claim 30, wherein an ambient air temperature at the wastewater treatment system is greater than 15° C. (59° F.).

48. The method of claim 30, wherein an ambient air temperature at the wastewater treatment system is about 30° C. (86° F.) and greater.

49. The method of claim 30, wherein an ambient air temperature at the wastewater treatment system is from about 27° C. (80.6° F.) to 39° C. (102.2° F.)

50. The method of claim 30, wherein mesophilic microbes are added to the wastewater.

51. The method of claim 50, wherein a temperature of the wastewater at a point of addition of the mesophilic microbes is at least 5° C. (25° F.) cooler than the temperature of the influent wastewater stream.

52. The method of claim 50, wherein a temperature of the wastewater at a point of addition of the mesophilic microbes is at least 10° C. (50° F.) cooler than the temperature of the influent wastewater stream.

53. The method of claim 50, wherein a temperature of the wastewater at a point of addition of the mesophilic microbes is at least 15° C. (59° F.) cooler than the temperature of the influent wastewater stream.

54. The method of claim 50, wherein a temperature of the wastewater at a point of addition of the mesophilic microbes is at least 20° C. (68° F.) cooler than the temperature of the influent wastewater stream.

55. The method of claim 50, wherein a temperature of the wastewater at a point of addition of the mesophilic microbes is at least 5° C. (25° F.) cooler than the temperature of the wastewater at a point of addition of the thermophilic microbes.

56. The method of claim 50, wherein a temperature of the wastewater at a point of addition of the mesophilic microbes is at least 10° C. (50° F.) cooler than the temperature of the influent wastewater stream.

57. The method of claim 50, wherein a temperature of the wastewater at a point of addition of the mesophilic microbes is at least 15° C. (59° F.) cooler than the temperature of the influent wastewater stream.

58. The method of claim 50, wherein a temperature of the wastewater at a point of addition of the mesophilic microbes is at least 20° C. (68° F.) cooler than the temperature of the influent wastewater stream.

59. The method of claim 1, wherein a sludge is produced.

60. The method of claim 1 or 30, wherein the sludge has a fecal coliform level of less than 1,000 most probable number (MPN) per gram of total solids (dry weight), and a salmonella sp. bacterium of less than 3 MPN per 4 grams total solids (dry weight).

61. The method of claim 30, wherein a second dose of microbes is added to the fourth treatment device.

62. The method of claim 30, wherein the second device does not have oxygen added to it.

63. The methods of claim 1 or 30, wherein the influent wastewater stream is from a paper mill.

64. The methods of claim 1 or 30, wherein the influent wastewater stream is from a pulp mill.

65. The method of claim 1 or 30, wherein the thermophilic microbes are one or more the microbes listed in Table 2.

66. The method of claim 1 or 30, wherein the thermophilic microbes are selected from one or more the genera of microbes listed in Table 1.

67. The method of claim 1 or 30, wherein at least 50% of the effluent from the wastewater treatment system is reused, wherein at least 60% of the effluent from the wastewater treatment system is reused, wherein at least 80% of the effluent from the wastewater treatment system is reused, wherein at least 90% of the effluent from the wastewater treatment system is reused, and wherein at least 95% of the effluent from the wastewater treatment system is reused.
